(19) United States
(12) Patent Application Publication
(10) Pub. No.: US 2026/0300554 A1
(43) Pub. Date: Oct. 1, 2026

(54) INFORMATION PROCESSING SYSTEM, SIGNAL PROCESSING DEVICE, AND AUXILIARY DEVICE

(71) Applicant: MegaChips Corporation, Osaka (JP)

(72) Inventors: Tomohito FUJIE, Osaka (JP); Naoki MATSUYAMA, Osaka (JP); Tatsunori KOGA, Osaka (JP)

(73) Assignee: MegaChips Corporation, Osaka (JP)

(21) Appl. No.: 19/414,315

(22) Filed: Dec. 10, 2025

(30) Foreign Application Priority Data
Mar. 28, 2025 (JP) 2025-056083

(51) Int. Cl. G06F 21/71

(52) U.S. Cl. CPC G06F 21/71

(57) ABSTRACT

An information processing system includes a signal processing device including a first circuitry, and an auxiliary device connected to the signal processing device and including a second circuitry, in which the first circuitry generates a clock signal and a plurality of data signals having different relative phase differences with respect to the clock signal, and receives response data that the second circuitry generates based on the clock signal and the plurality of data signals, and the first circuitry includes a storage circuit that stores expected value data, and the first circuitry determines that the auxiliary device is a genuine product or the auxiliary device is a non-genuine product based on the expected value data and the response data.

### CROSS-REFERENCE TO RELATED APPLICATION

The present application is based on, and claims priority from Japanese Patent Application Serial Number 2025-056083, filed on Mar. 28, 2025, the disclosure of which is hereby incorporated by reference herein in its entirety.

### FIELD OF INVENTION

The present invention relates to an information processing system, a signal processing device, and an auxiliary device.

### BACKGROUND ART

JP 2010-79410 A discloses a technique for identifying a genuine product and a counterfeit product by comparing consumption current values. Specifically, JP 2010-79410 A discloses a processing device in a software processing system including a memory device having software, a processing device that reads and processes the software of the memory device, a power supply device that supplies power, and a power feeding device that supplies power supplied from the power supply device to the memory device. The power feeding device includes a power processing means for supplying power from the power supply device to the memory device in response to an access from the processing device, measuring the supplied power, and storing a measurement result. The processing device stores power consumption data related to power consumption of the memory device in a ROM incorporated in a CPU, and includes a controlling means for accessing the power feeding device, reading a measurement result from the power feeding device, and comparing the read measurement result with the power consumption data to determine whether the memory device is a genuine product.

In the technique described in JP 2010-79410 A, in a case where a malicious third party falsifies a power consumption amount by causing a memory device that is a counterfeit product to perform an intentional power consumption operation, it is difficult for the processing device (signal processing device) to identify whether or not the memory device (auxiliary device) is a genuine product.

### SUMMARY OF THE INVENTION

The present invention has been made in view of the above problem, and an object of the present invention is to provide a technique capable of accurately identifying whether or not an auxiliary device connected to a signal processing device is a genuine product.

An information processing system according to one aspect of the present invention includes a signal processing device including a first circuitry, and an auxiliary device connected to the signal processing device and including a second circuitry, in which the first circuitry generates a clock signal and a plurality of data signals having different relative phase differences with respect to the clock signal, and transmits the clock signal and the plurality of data signals to the second circuitry, the second circuitry receives the clock signal and the plurality of data signals, generates response data based on the clock signal and the plurality of data signals, and transmits the response data to the first circuitry, and the first circuitry receives the response data, includes a storage circuit that stores expected value data, and determines that the auxiliary device is a genuine product or the auxiliary device is a non-genuine product based on the expected value data and the response data.

### BRIEF DESCRIPTION OF THE DRAWINGS

FIG. 1 is a diagram illustrating a configuration of an information processing system according to a first embodiment in a simplified manner;

FIG. 2 is a diagram illustrating a configuration of a host device according to the first embodiment in a simplified manner;

FIG. 3 is a diagram illustrating a configuration of a memory device according to the first embodiment in a simplified manner;

FIG. 4 is a diagram illustrating a flow of data in the information processing system according to the first embodiment;

FIG. 5 is a flowchart illustrating a flow of authentication processing executed by the host device according to the first embodiment;

FIG. 6 is a diagram schematically illustrating data transmitted and received between the host device and the memory device in the first embodiment;

FIG. 7A is a diagram illustrating a configuration of the information processing system according to Modification Example 1-3 in a simplified manner;

FIG. 7B is a diagram illustrating another example of the configuration of the information processing system according to Modification Example 1-3 in a simplified manner;

FIGS. 8A to 8D are diagrams schematically illustrating that a timing at which a data signal is received by a flip-flop circuit differs for each transmission path;

FIG. 9 is a diagram illustrating a configuration of the memory device according to Modification Example 1-5 in a simplified manner;

FIG. 10 is a diagram illustrating a configuration of a part of a drive capability changing circuit;

FIG. 11 is a truth table of the drive capability changing circuit illustrated in FIG. 10;

FIG. 12 is a diagram illustrating another example of the configuration of the drive capability changing circuit;

FIG. 13 is a truth table of the drive capability changing circuit illustrated in FIG. 12;

FIG. 14 is a diagram schematically illustrating data transmitted and received between the host device and the memory device in Modification Example 1-5;

FIG. 15 is a diagram illustrating a configuration of the host device according to Modification Example 1-6 in a simplified manner;

FIG. 16 is a diagram schematically illustrating data transmitted and received between the host device and the memory device in Modification Example 1-6;

FIG. 17 is a diagram schematically illustrating current flowing from the memory device to a constant current source in a case where a High response instruction is transmitted from the host device to the memory device;

FIG. 18 is a diagram schematically illustrating current flowing from the constant current source to the memory device in a case where a Low response instruction is transmitted from the host device to the memory device;

FIG. 19 is a table illustrating a relationship between setting of drive capability of the host device, setting of drive capability of the memory device, and a voltage level of response data generated by a combination of these drive capabilities;

FIG. 20 is a diagram illustrating a configuration of the host device according to Modification Example 1-7 in a simplified manner;

FIG. 21 is a diagram illustrating a configuration of the host device according to Modification Example 1-8 in a simplified manner;

FIG. 22 is a diagram illustrating an internal configuration of a controller of the memory device according to Modification Example 1-8 in a simplified manner;

FIG. 23 is a diagram illustrating an internal configuration of a controller of the memory device according to Modification Example 1-9 in a simplified manner;

FIG. 24 is a diagram illustrating a state in which a predetermined value is set in each flip-flop circuit of a scan circuit according to Modification Example 1-9;

FIG. 25 is a diagram illustrating a state in which each flip-flop circuit of the scan circuit according to Modification Example 1-9 is updated;

FIG. 26 is a diagram illustrating a state in which a value set in each flip-flop circuit of the scan circuit according to Modification Example 1-9 is output from a scan-out terminal;

FIG. 27 is a diagram schematically illustrating data transmitted and received between the host device and the memory device in Modification Example 1-10;

FIG. 28 is a diagram schematically illustrating data transmitted and received between the host device and the memory device in Modification Example 1-11;

FIG. 29 is a diagram illustrating an example of a configuration of a first voltage variable circuit;

FIG. 30 is a diagram illustrating another example of the configuration of the first voltage variable circuit;

FIG. 31 is a diagram illustrating another example of a configuration of a second voltage variable circuit;

FIG. 32 is a diagram illustrating a configuration of the information processing system according to a second embodiment in a simplified manner;

FIG. 33 is a diagram illustrating a configuration of the host device according to the second embodiment in a simplified manner;

FIG. 34 is a diagram illustrating a configuration of the memory device according to the second embodiment in a simplified manner;

FIG. 35 is a diagram illustrating a flow of data in the information processing system according to the second embodiment;

FIG. 36 is a flowchart illustrating a flow of authentication processing executed by the host device according to the second embodiment;

FIG. 37 is a diagram schematically illustrating data transmitted and received between the host device and the memory device in the second embodiment; and

FIG. 38 is a diagram schematically illustrating an overall configuration of the information processing system according to Modification Example 2-4 and data transmitted and received between the host device and the memory device.

### DETAILED DESCRIPTION

Hereinafter, an information processing system according to the present invention will be described. All embodiments described below show one specific example of the present invention. Numerical values, shapes, constituent elements, steps, order of steps, and the like described in the embodiments below are merely examples, and are not intended to limit the present invention. Further, among constituent elements in the embodiments below, a constituent element that is not described in an independent claim indicating the highest concept is described as an optional constituent element. Further, in all the embodiments, the content of each can be combined with one another. Note that elements denoted by the same reference numerals in different drawings represent the same or corresponding elements.

### First Embodiment

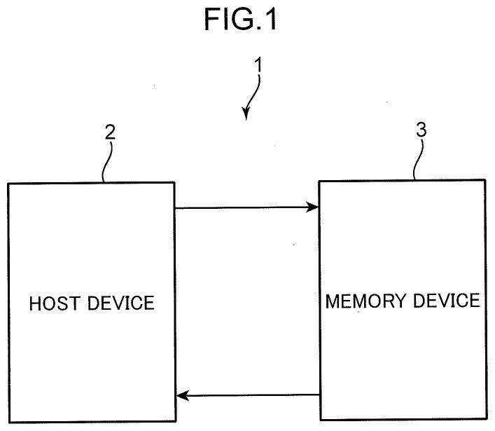

FIG. 1 is a diagram illustrating a configuration of an information processing system 1 according to a first embodiment in a simplified manner. As illustrated in FIG. 1, the information processing system 1 includes a host device 2 (an example of a signal processing device) and a memory device 3 (an example of an auxiliary device) detachably connected to the host device 2. The host device 2 is, for example, an information processing device such as a personal computer, and the memory device 3 is, for example, a memory card of a flash memory that operates by receiving power supply from the host device 2. However, this is an example, and the configuration of the information processing system 1 is not limited to this. As another example, the information processing system 1 may include a main body of a printer or a multifunction peripheral (an example of a signal processing device), and a toner cartridge (an example of an auxiliary device) connected to the main body. Alternatively, the information processing system 1 may include a main body of a game machine (an example of a signal processing device) and a memory card (an example of an auxiliary device) that stores a game program and the like and is connected to the main body of the game machine. In addition, the configuration of the information processing system 1 can be changed as appropriate. The host device 2 includes a first circuitry including, for example, a semiconductor circuit. The memory device 3 includes a second circuitry including, for example, a semiconductor circuit.

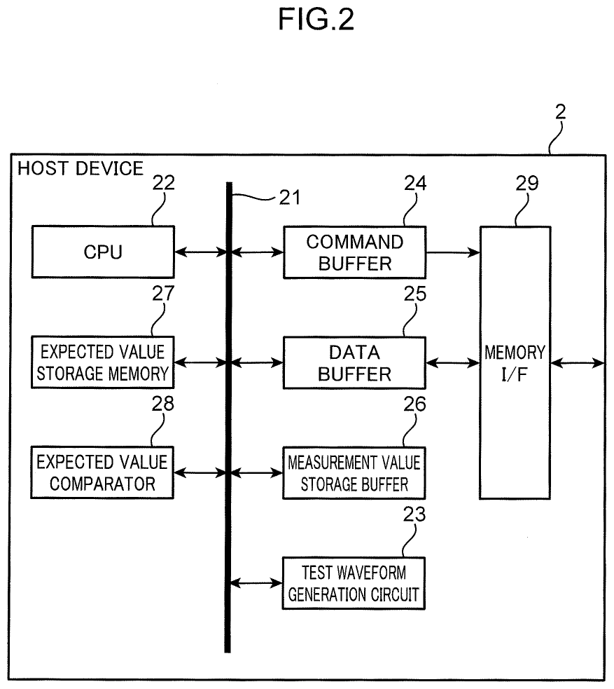

FIG. 2 is a diagram illustrating a configuration of the host device 2 in a simplified manner. In other words, FIG. 2 is a diagram illustrating a configuration of the first circuitry included in the host device 2 in a simplified manner. As illustrated in FIG. 2, the first circuitry of the host device 2 includes a plurality of processing blocks such as a CPU 22, a test waveform generation circuit 23, a command buffer 24, a data buffer 25, a measurement value storage buffer 26, an expected value storage memory 27, an expected value comparator 28, and a memory interface (I/F) 29, which are mutually connected via a bus 21.

The CPU 22 controls overall operation of the host device 2.

The test waveform generation circuit 23 generates a clock signal CLK and at least one data signal D1. The clock signal CLK and the at least one of data signal D1 are transmitted from the memory I/F 29 to the memory device 3 via the command buffer 24 and the data buffer 25.

The measurement value storage buffer 26 stores response data D2 received from the memory device 3. The response data D2 will be described later.

The expected value storage memory 27 (an example of a storage circuit) stores expected value data D3. The expected value data D3 is data indicating that the memory device 3 is a genuine product. In a case where the memory device 3 is a genuine product, the expected value data D3 and the response data D2 match each other.

The expected value comparator 28 determines whether or not the memory device 3 is a genuine product based on a comparison result between the expected value data D3 stored in the expected value storage memory 27 and the response data D2 stored in the measurement value storage buffer 26. In a case where the expected value data D3 matches the response data D2, the expected value comparator 28 determines that the memory device 3 is a genuine product. On the other hand, in a case where the expected value data D3 and the response data D2 do not match, the expected value comparator 28 determines that the memory device 3 is a counterfeit product (non-genuine product).

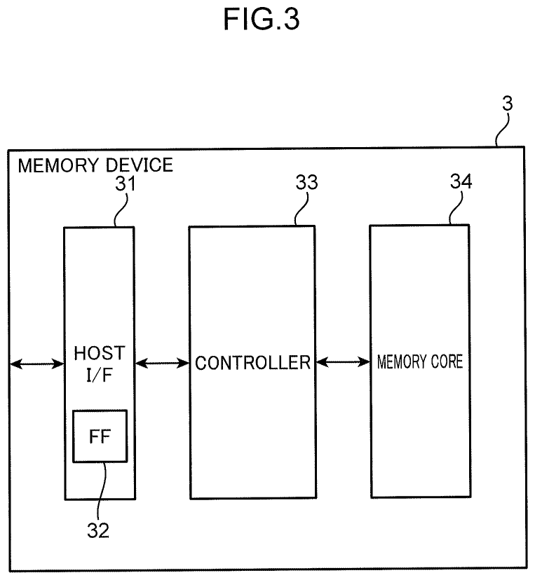

FIG. 3 is a diagram illustrating a configuration of the memory device 3 in a simplified manner. In other words, FIG. 3 is a diagram illustrating a configuration of the second circuitry included in the memory device 3 in a simplified manner. As illustrated in FIG. 3, the second circuitry of the memory device 3 includes a plurality of processing blocks such as a host I/F 31, a controller 33, and a memory core 34. The controller 33 controls overall operation of the memory device 3. The memory core 34 stores various data such as content data.

The host I/F 31 includes a flip-flop circuit 32. The flip-flop circuit 32 acquires the clock signal CLK and the at least one of data signal D1 received by the host I/F 31. Further, the flip-flop circuit 32 reads a plurality of data signals received by the host I/F 31, and sends the read data back to the memory I/F 29 of the host device 2 without modification. Note that, in FIG. 3, the flip-flop circuit 32 is denoted as “FF”.

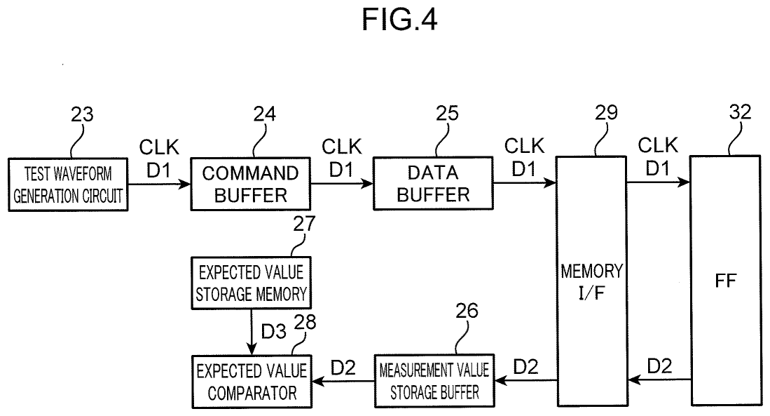

FIG. 4 is a diagram illustrating a flow of data in the information processing system 1 according to the first embodiment. As illustrated in FIG. 4, the test waveform generation circuit 23 generates the clock signal CLK and the at least one of data signal D1. These pieces of data are transmitted to the host I/F 31 via the command buffer 24, the data buffer 25, and the memory I/F 29. The flip-flop circuit 32 of the host I/F 31 receives the clock signal CLK and the at least one of data signal D1, generates the response data D2 based on these signals, and transmits the response data D2 to the memory I/F 29. The response data D2 received by the memory I/F 29 is stored in the measurement value storage buffer 26. The response data D2 stored in the measurement value storage buffer 26 and the expected value data D3 stored in the expected value storage memory 27 are input to the expected value comparator 28.

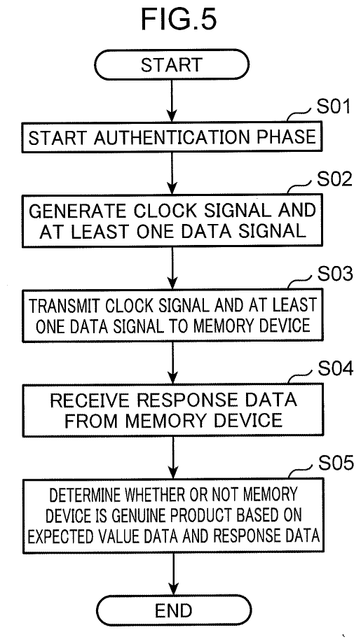

FIG. 5 is a flowchart illustrating a flow of authentication processing executed by the host device 2 according to the first embodiment.
First, in Step S01, the host device 2 transitions from a normal phase to an authentication phase. The normal phase is a phase in which the host device 2 executes a normal operation. The authentication phase is a phase for executing authentication processing for determining whether the memory device 3 is a genuine product. The host device 2 transitions to the authentication phase, for example, at the time of startup or periodically. In addition, the host device 2 may transition to the authentication phase when the memory device 3 is connected.
In Step S02, the test waveform generation circuit 23 of the host device 2 generates the clock signal CLK and the at least one of data signal D1.
In Step S03, the memory I/F 29 of the host device 2 transmits the clock signal CLK and the at least one of data signal D1 to the host I/F 31 of the memory device 3.
In Step S04, the memory I/F 29 of the host device 2 receives the response data D2 sent back by the flip-flop circuit 32. The response data D2 is stored in the measurement value storage buffer 26.
In Step S05, the expected value comparator 28 of the host device 2 determines whether or not the memory device 3 is a genuine product based on the expected value data D3 stored in the expected value storage memory 27 and the response data D2 stored in the measurement value storage buffer 26.

In a case where the expected value comparator 28 determines that memory device 3 is a genuine product, the host device 2 transitions from the authentication phase to the normal phase. That is, the host device 2 resumes the normal operation. On the other hand, in a case where the expected value comparator 28 determines that the memory device 3 is a counterfeit product, the host device 2 stops operation of the host device 2 and the memory device 3. Alternatively, the host device 2 may perform re-authentication. As a result of re-authentication, in a case where the expected value comparator 28 again determines that the memory device 3 is a counterfeit product, the host device 2 may stop operation of the host device 2 and the memory device 3.

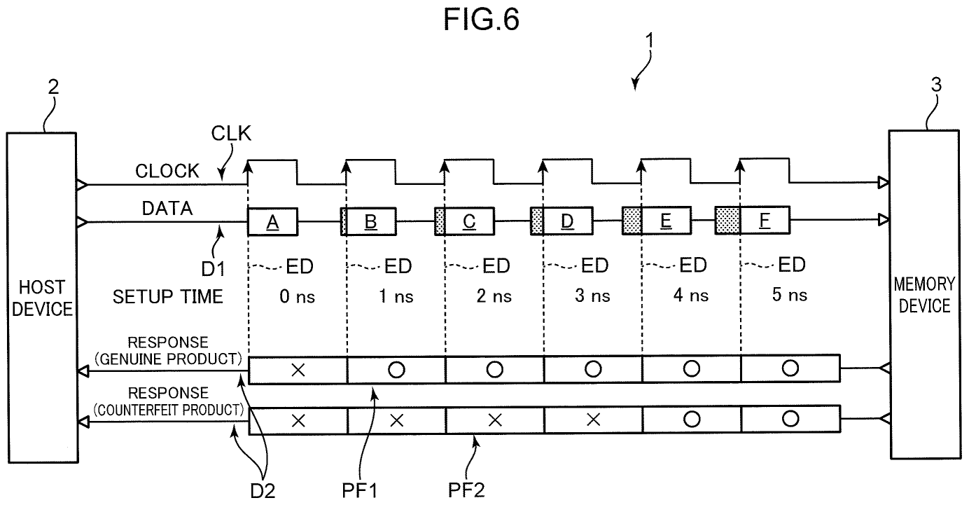

FIG. 6 is a diagram schematically illustrating data transmitted and received between the host device 2 and the memory device 3 in the first embodiment. A flow of processing in the information processing system 1 will be described with reference to FIG. 6.

First, the host device 2 transitions to the authentication phase at the time of startup or periodically.

Next, the test waveform generation circuit 23 of the host device 2 generates the clock signal CLK and the at least one of data signal D1 for verifying setup time of the memory device 3. The clock signal CLK is a signal in which “0 (Low)” and “1 (High)” are alternately repeated at a constant cycle. Note that a broken line illustrated in FIG. 6 indicates a clock edge ED.

Next, the host device 2 transfers (transmits) the clock signal CLK and the at least one of data signal D1 to the memory device 3 via the command buffer 24, the data buffer 25, and the memory I/F 29.

In the example illustrated in FIG. 6, the test waveform generation circuit 23 generates a plurality of data signals as the at least one of data signal D1. A plurality of the data signals include a first data signal A, a second data signal B, a third data signal C, a fourth data signal D, a fifth data signal E, and a sixth data signal F. Each of the first data signal A to the sixth data signal F is 1-bit information indicating a value (logical value) of “0” or “1”. However, this is an example, and the at least one data signal may have a multi-bit width.

In the example illustrated in FIG. 6, relative phase differences of a plurality of data signals with respect to the clock signal CLK are different from each other. That is, an output timing of each data signal is different for each data signal. For example, the first data signal A is output at a timing when there is no setup time for determining a value indicated by the first data signal A. On the other hand, the second data signal B is output at a timing when setup time is 1 nanosecond. Further, the third data signal C is output at a timing when setup time is 2 nanoseconds, the fourth data signal D is output at a timing when setup time is 3 nanoseconds, the fifth data signal E is output at a timing when setup time is 4 nanoseconds, and the sixth data signal F is output at a timing when setup time is 5 nanoseconds. That is, the host device 2 shifts an output timing of each data signal with respect to the clock edge ED of the clock signal CLK. Note that, in FIG. 6, the setup time is indicated by hatching. The clock signal CLK and a plurality of the data signals are received by the flip-flop circuit 32 of the host I/F 31.

Next, the flip-flop circuit 32 reads a plurality of data signals transmitted from the host device 2, and sends the read data back to the host device 2 without modification.

Next, the memory I/F 29 of the host device 2 receives the data sent back from the flip-flop circuit 32, that is, the response data D2. Then, the host device 2 determines whether or not a value indicated by the data signal can be determined by the flip-flop circuit 32 of a genuine product.

Genuine product pass/fail information PF1 illustrated in FIG. 6 indicates content of pass/fail information generated by the host device 2 based on the response data D2 in a case where the memory device 3 is a genuine product. A symbol “○” indicates that a value indicated by a data signal is determined by the flip-flop circuit 32 of a genuine product. On the other hand, a symbol “×” indicates that a value indicated by a data signal cannot be determined by the flip-flop circuit 32 of a genuine product. Therefore, the genuine product pass/fail information PF1 in FIG. 6 indicates that the flip-flop circuit 32 of the memory device 3 as a genuine product fails in determining a value indicated by the first data signal A and successfully determines values indicated by the second data signal B to the sixth data signal F.

Further, counterfeit product pass/fail information PF2 illustrated in FIG. 6 indicates pass/fail information generated by the host device 2 based on the response data D2 in a case where the memory device 3 is a counterfeit product. A symbol “○” indicates that a value indicated by a data signal is determined by the flip-flop circuit 32 of a counterfeit product, and a symbol “×” indicates that a value indicated by a data signal is not determined by the flip-flop circuit 32 of a counterfeit product. Therefore, the counterfeit product pass/fail information PF2 in FIG. 6 indicates that the flip-flop circuit 32 of the memory device 3 as a counterfeit product fails in determining values indicated by the first data signal A to the fourth data signal D, and successfully determines values indicated by the fifth data signal E and the sixth data signal F.

Note that the pass/fail information may be generated by the memory device 3. In this case, the memory device 3 may transmit the response data D2 including the pass/fail information to the host device 2.

The pass/fail information generated by the host device 2 based on the response data D2 is stored in the measurement value storage buffer 26 together with the response data D2.

Next, the expected value comparator 28 of the host device 2 compares the expected value data D3 in the expected value storage memory 27 with the pass/fail information in the measurement value storage buffer 26. In the example illustrated in FIG. 6, the expected value storage memory 27 of the host device 2 stores, as the expected value data D3, pass/fail information having the same content (pattern) as the genuine product pass/fail information PF1. Therefore, in a case where the genuine product pass/fail information PF1 is generated based on the response data D2 received from the memory device 3, the expected value comparator 28 determines that the memory device 3 is a genuine product. On the other hand, in a case where the counterfeit product pass/fail information PF2 is generated based on the response data D2 received from the memory device 3, that is, in a case where pass/fail information that does not match the expected value data D3 is generated, the expected value comparator 28 determines that the memory device 3 is a counterfeit product.

In a case where the expected value comparator 28 determines that memory device 3 is a genuine product, the host device 2 transitions from the authentication phase to the normal phase. On the other hand, in a case where the expected value comparator 28 determines that the memory device 3 is a counterfeit product, the host device 2 stops operation of the host device 2 and the memory device 3 or performs re-authentication.

As described above, according to the information processing system 1 according to the present embodiment, it is determined whether or not the memory device 3 is a genuine product by using the response data D2 generated based on the clock signal CLK and the at least one of data signal D1. Therefore, according to the information processing system 1, it is possible to accurately identify whether or not the memory device 3 is a genuine product.

Further, the host device 2 according to the present embodiment transmits a plurality of data signals having different relative phase differences with respect to the clock signal CLK to the memory device 3. That is, a timing of outputting a data signal is shifted for each data signal. By this, the host device 2 adjusts setup time and hold time. In general, since counterfeit products are often inferior products, for example, when a plurality of data signals are transmitted in a manner that setup time is gradually shortened, performance reaches the limit in due course, and the memory device 3 as a counterfeit product cannot determine a value indicated by a data signal. On the other hand, since a genuine product is often designed with a higher specification than a counterfeit product, a value indicated by a data signal can be determined even in a case where setup time is short. Further, on the contrary, in a case where setup time is set to such a length that a value indicated by a data signal cannot be determined by the memory device 3 as a genuine product, the memory device 3 as a counterfeit product may determine a value indicated by a data signal. As described above, capability (specification) to determine a value indicated by a data signal is different between a genuine product and a counterfeit product. This difference in specification is reflected in the response data D2. That is, the response data D2 sent back from the memory device 3 as a counterfeit product to the host device 2 is different from the response data D2 sent back from the memory device 3 as a genuine product to the host device 2. Then, since pass/fail information generated based on the response data D2 generated by a counterfeit product does not match the expected value data D3 stored in the expected value storage memory 27, the expected value comparator 28 determines that the product is a counterfeit product. As described above, in the present embodiment, authenticity determination of the memory device 3 is performed using a characteristic that is difficult to intentionally falsify, such as ability to determine a value indicated by a data signal. For this reason, the host device 2 can accurately identify whether or not the memory device 3 is a genuine product. Further, in the present embodiment, since authenticity determination of the memory device 3 is performed using a characteristic that it is difficult to intentionally falsify, that is, ability to determine a value indicated by a data signal, it is difficult to counterfeit the memory device 3.

Hereinafter, various modification example examples of the first embodiment will be described.

### Modification Example 1-1

The host device 2 may also transmit only data signals before and after a boundary between success and failure of determination of a logical value to the memory device 3. Referring to FIG. 6 as an example, the host device 2 may also transmit only the first data signal A having setup time of 0 nanoseconds and the second data signal B having setup time of 1 nanosecond to the memory device 3. In this way, if the memory device 3 is a genuine product, the host device 2 generates pass/fail information indicating that determination of a value indicated by the first data signal A fails and determination of a value indicated by the second data signal B succeeds. On the other hand, if the memory device 3 is a counterfeit product, pass/fail information indicating that determination of values indicated by the first data signal A and the second data signal B fails is generated. For this reason, the expected value comparator 28 can accurately identify whether the memory device 3 is a genuine product or a counterfeit product. As described above, even in a case where only data signals before and after a boundary between success and failure of determination of a logical value are transmitted, the same effect as that of the first embodiment can be obtained.

Further, according to the present modification example, since a transmission amount of a data signal can be reduced as compared with a case of transmitting data signals (the third data signal C to the sixth data signal F in the example of FIG. 6) other than data signals before and after a boundary, authentication processing is made efficient.

### Modification Example 1-2

Invalid data may be included in at least one of a data signal transmitted from the host device 2 to the memory device 3 and the response data D2 transmitted from the memory device 3 to the host device 2.

Referring to FIG. 6 as an example, for example, the host device 2 may determine the third data signal C as invalid data, and determine the first data signal A, the second data signal B, the fourth data signal D, the fifth data signal E, and the sixth data signal F as determination data.

A timing at which the host device 2 transmits invalid data to the memory device 3 is shared between the host device 2 and the memory device 3 in advance. For example, a timing of transmitting invalid data is shared between the host device 2 and the memory device 3 as a genuine product by encrypted communication or the like. Alternatively, in the memory device 3 as a genuine product, information regarding a transmission timing of invalid data may be stored in the memory core 34 at the time of factory shipment or the like.

In a case where a data signal includes invalid data, the memory device 3 causes the flip-flop circuit 32 to receive the data signal excluding the invalid data. In this way, in a case where the memory device 3 is a genuine product, only a data signal excluding the third data signal C, that is, determination data is sent back from the flip-flop circuit 32 to the host device 2. On the other hand, in a case where the memory device 3 is a counterfeit product, the response data D2 including information regarding the third data signal C, which is invalid data, is sent back from the flip-flop circuit 32 to the host device 2. Therefore, the expected value comparator 28 can easily identify the memory device 3 as a genuine product and the memory device 3 as a counterfeit product.

There is a case where a malicious third party analyzes the response data D2 of the memory device 3 as a genuine product, but according to the present modification example, content of the response data D2 is complicatedly changed according to the presence or absence of invalid data. For this reason, analysis difficulty of the response data D2 is improved. As a result, forgery difficulty of the memory device 3 is improved.

### Modification Example 1-3

The host I/F 31 may further include a plurality of transmission paths. The clock signal CLK or a plurality of data signals transmitted from the host device may be acquired by a flip-flop circuit via any one of a plurality of transmission paths. A delay amount of the clock signal CLK or a plurality of data signals in each of a plurality of transmission paths may be different for each of a plurality of transmission paths.

Hereinafter, a case where a plurality of data signals having different phase differences with respect to the clock signal CLK are acquired by a flip-flop circuit via any one of a plurality of transmission paths will be described as an example. In this case, it would be sufficient for the clock signal CLK to be received by the flip-flop circuit via a path (clock line) for the clock signal CLK.

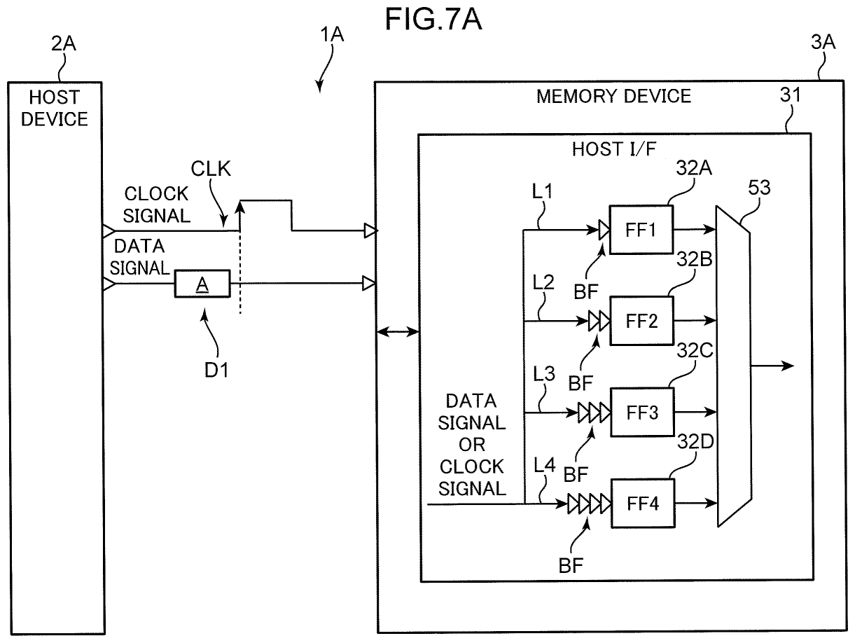

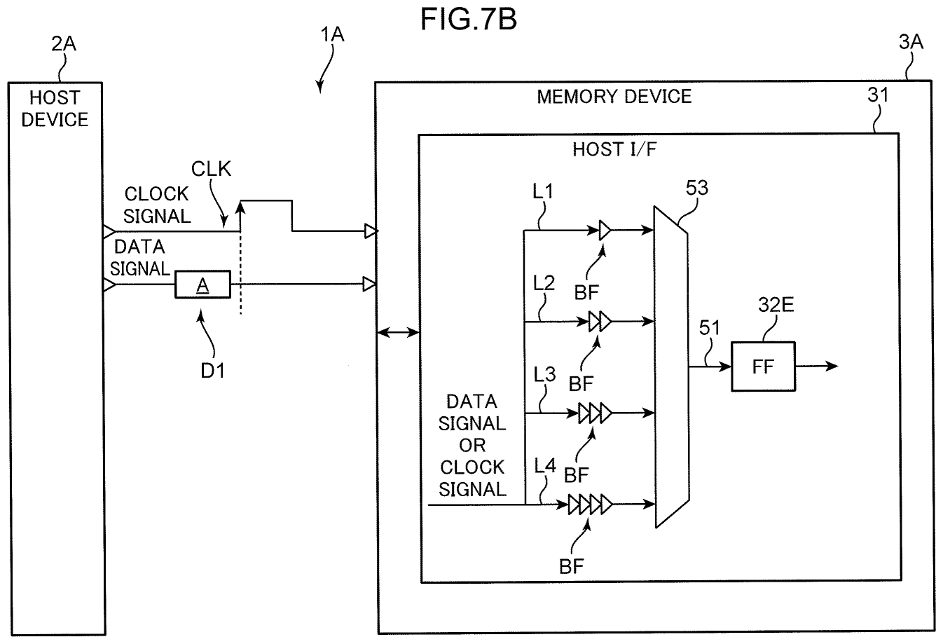

FIG. 7A is a diagram illustrating a configuration of an information processing system 1A according to the present modification example in a simplified manner. In FIG. 7A, only the first data signal A of a plurality of data signals is illustrated, and illustration of other data signals is omitted. As illustrated in FIG. 7A, the information processing system 1A includes a host device 2A and a memory device 3A. The host device 2A includes a first circuitry, and the memory device 3A includes a second circuitry. The host I/F 31 included in the second circuitry of the memory device 3A includes four transmission paths arranged in parallel. Hereinafter, these transmission paths are referred to as a first transmission path L1, a second transmission path L2, a third transmission path L3, and a fourth transmission path L4. One delay element BF and a first flip-flop circuit 32A are provided in the first transmission path L1. Two of the delay elements BF and a second flip-flop circuit 32B are provided in the second transmission path L2. Three of the delay elements BF and a third flip-flop circuit 32C are provided in the third transmission path L3. Four of the delay elements BF and a fourth flip-flop circuit 32D are provided in the fourth transmission path L4. Output of each of the transmission paths is connected to a selector 53. In a case where a plurality of data signals pass through the first transmission path L1, a plurality of the data signals are received by the first flip-flop circuit 32A after passing through one of the delay elements BF, and are input to the selector 53. Similarly, a plurality of data signals are received by respective flip-flop circuits after passing through two of the delay elements BF in a case where a plurality of the data signals pass through the second transmission path L2, after passing through three of the delay elements BF in a case where a plurality of the data signals pass through the third transmission path L3, and passing through four of the delay elements BF in a case where a plurality of the data signals pass through the fourth transmission path L4, and input to the selector 53. The selector 53 sends a plurality of data signals read by any of the flip-flop circuits back to the host device 2A without modification. The delay element BF delays time until a plurality of data signals transmitted from the memory I/F 29 is received by a flip-flop circuit. As the number of the delay elements BF increases, the delay amount also increases. The delay element BF includes, for example, a buffer. A transmission path through which each of a plurality of data signals passes may be selected by the selector 53.

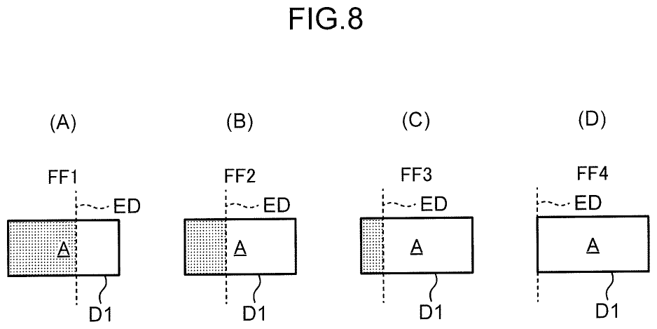

FIGS. 8A to 8D are diagrams schematically illustrating that a timing at which the first data signal A, which is one of a plurality of data signals, is received by a flip-flop circuit differs for each transmission path. Specifically, FIG. 8A illustrates a phase difference between the first data signal A and the clock signal CLK in a case where the first data signal A is received by the first flip-flop circuit 32A via first transmission path L1. FIG. 8B illustrates a phase difference between the first data signal A and the clock signal CLK in a case where the first data signal A is received by the second flip-flop circuit 32B via the second transmission path L2. FIG. 8C illustrates a phase difference between the first data signal A and the clock signal CLK in a case where the first data signal A is received by the third flip-flop circuit 32C via the third transmission path L3. FIG. 8D illustrates a phase difference between the first data signal A and the clock signal CLK in a case where the first data signal A is received by the fourth flip-flop circuit 32D via the fourth transmission path L4.

As illustrated in FIGS. 8A to 8C, in a case of passing through the first transmission path L1, the second transmission path L2, or the third transmission path L3, there is setup time for determining a value indicated by the first data signal A. Therefore, the first flip-flop circuit 32A, the second flip-flop circuit 32B, or the third flip-flop circuit 32C can determine a value indicated by the first data signal A. On the other hand, as illustrated in FIG. 8D, in a case where the first data signal A passes through the fourth transmission path L4, there is no setup time. For this reason, in a case where the first data signal A passes through the fourth transmission path L4, the fourth flip-flop circuit 32D fails to determine a value indicated by the first data signal A. As described above, in the present modification example, whether or not a value indicated by a data signal can be determined changes according to which transmission path among a plurality of transmission paths the data signal passes through. In other words, content of pass/fail information changes depending on which transmission path is used.

The host device 2A according to the present modification example determines one specific transmission path through which a plurality of data signals pass from among the first transmission path L1 to the fourth transmission path L4. The specific transmission path may be determined dynamically or statically. In a case of dynamic determination, the host device 2A determines the specific transmission path again, for example, each time transition is made to the authentication phase. The host device 2A shares the specific transmission path with the memory device 3A. The memory device 3A operates the selector 53 so that a plurality of data signals pass through the specific transmission path shared with the host device 2A. As a method of sharing the specific transmission path, there are three examples below. (i) A common transmission path selection pattern is held between the host device 2A and the memory device 3A in advance. (ii) The host device 2A and the memory device 3A generate a common transmission path selection pattern based on a common rule. (iii) A transmission path selection pattern is transmitted from the host device 2A to the memory device 3A by encrypted communication. Regarding (i), for example, it would be sufficient that a common transmission path selection pattern be stored in the expected value storage memory 27 of the host device 2A and the memory core 34 of the memory device 3A. These pieces of information only need to be stored, for example, at the time of factory shipment of each of the host device 2A and the memory device 3A as a genuine product. Regarding (ii), for example, a common random number generation circuit for generating random numbers from 1 to 4 may be mounted on the host device 2A and the memory device 3A, and the specific transmission path may be determined according to an output value of the random number generation circuit.

The expected value storage memory 27 according to the present modification example stores expected value data in a case where a plurality of data signals pass through the first transmission path L1, expected value data in a case where a plurality of data signals pass through the second transmission path L2, expected value data in a case where a plurality of data signals pass through the third transmission path L3, and expected value data in a case where a plurality of data signals pass through the fourth transmission path L4. The expected value comparator 28 may switch expected value data to be referred to according to a transmission path selection result.

According to the present modification example, whether or not a flip-flop circuit can determine a value indicated by each data signal changes depending on which transmission path the clock signal CLK or a plurality of data signals pass through. As a result, a variation is generated in a pattern of pass/fail information generated by the host device 2A based on the response data D2. In particular, as transmission paths are switched while output timings of a plurality of data signals are shifted, the number of patterns of pass/fail information further increases. The expected value comparator 28 of the host device 2A switches the expected value data D3 to be referred to according to a selected transmission path. In this way, a malicious third party is forced to manufacture a counterfeit product capable of supporting pass/fail information having various change patterns. As a result, forgery difficulty of the memory device 3A is improved.

Here, the example in which one of the delay elements BF is provided in the first transmission path L1, two of the delay elements BF are provided in the second transmission path L2, three of the delay elements BF are provided in the third transmission path L3, and four of the delay elements BF are provided in the fourth transmission path L4 is described, but the number of the delay elements BF can be appropriately changed. For example, the configuration may be such that the delay element BF is not provided in the first transmission path L1, one of the delay elements BF is provided in the second transmission path L2, two of the delay elements BF are provided in the third transmission path L3, and three of the delay elements BF are provided in the fourth transmission path L4.

Note that the host device 2A may randomly determine the specific transmission path. In this case, it would be sufficient for the host device 2A to share the specific transmission path with the memory device 3A using, for example, encrypted communication or the like. In this way, since a malicious third party is forced to manufacture a counterfeit product capable of supporting randomly switched pass/fail information, forgery difficulty of the memory device 3 is improved.

In the present modification example, the example in which a plurality of data signals having different phase differences with respect to the clock signal CLK are received by a flip-flop circuit via any one of a plurality of transmission paths is described, but instead of this, the clock signal CLK may be received by a flip-flop circuit via any one of a plurality of transmission paths. In this case, different numbers of buffers may be arranged on a plurality of transmission paths of the clock signal CLK.

Further, in the present modification example, the example in which a flip-flop circuit is arranged in each of four transmission paths is described. That is, the example in which four flip-flop circuits are provided is described. However, as long as a buffer point is branched, transmission paths may be aggregated before one flip-flop circuit. FIG. 7B is a diagram illustrating another example of the configuration of the information processing system 1A according to Modification Example 1-3 in a simplified manner. As illustrated in FIG. 7B, the host I/F 31 of the information processing system 1A includes the first transmission path L1 to the fourth transmission path L4, the selector 53 connected to output of each of these transmission paths, and a fifth flip-flop circuit 32E. Further, the host I/F 31 includes a connection path 51 that is interposed between the selector 53 and the fifth flip-flop circuit 32E and connects output of the selector 53 and the fifth flip-flop circuit 32E. In the example illustrated in FIG. 7B, a data signal or a clock signal passes through any of four transmission paths, reaches the selector 53, and is input from the selector 53 to the fifth flip-flop circuit 32E via the connection path 51. A transmission path through which each of a plurality of data signals passes may be selected by the selector 53.

### Modification Example 1-4

In Modification Example 1-3, the example in which a plurality of data signals are received by a flip-flop circuit via any one specific transmission path among a plurality of transmission paths is described, but one data signal may be received by a flip-flop circuit via at least two transmission paths among a plurality of transmission paths.

Referring to FIG. 7A as an example, the host device 2A according to the present modification example determines at least two of a plurality of transmission paths as specific transmission paths. A determination result is shared with the memory device 3A. A sharing method is similar to that in the case of Modification Example 1-3. Then, the host device 2A transmits one data signal (for example, the first data signal A) to the memory device 3A.

As an example, the host device 2A determines all transmission paths from the first transmission path L1 to the fourth transmission path L4 as the specific transmission paths. In this case, one data signal (first data signal A) is received by all flip-flop circuits from the first flip-flop circuit 32A to the fourth flip-flop circuit 32D. Then, each of the first flip-flop circuit 32A to the fourth flip-flop circuit 32D sends the response data D2 back to the host device 2A. The host device 2A generates first pass/fail information based on the response data D2 acquired from the first flip-flop circuit 32A. Further, the host device 2A generates second pass/fail information based on the response data D2 acquired from the second flip-flop circuit 32B, third pass/fail information based on the response data D2 acquired from the third flip-flop circuit 32C, and fourth pass/fail information based on the response data D2 acquired from the fourth flip-flop circuit 32D.

The expected value data D3 corresponding to pass/fail information generated in a case where all transmission paths from the first transmission path L1 to the fourth transmission path L4 are determined as the specific transmission paths is stored in the expected value storage memory 27 according to the present modification example. The expected value comparator 28 determines whether or not the memory device 3A is a genuine product based on the expected value data D3 and the first pass/fail information to the fourth pass/fail information. In addition, the expected value storage memory 27 stores various pieces of the expected value data D3 such as the expected value data D3 corresponding to a case where the first transmission path L1 and the second transmission path L2 are selected as the specific transmission paths, and the expected value data D3 corresponding to a case where the second transmission path L2 and the third transmission path L3 are selected as the specific transmission paths.

According to the present modification example, when the host device 2A transmits one data signal, a plurality of (at least two) pieces of the response data D2 are sent back to the host device 2A. That is, the host device 2A receives the response data D2 sent back from a flip-flop circuit arranged in one of a plurality of transmission paths and the response data D2 sent back from a flip-flop circuit arranged in another one of a plurality of transmission paths. The host device 2A generates pass/fail information based on the response data D2. In the present modification example, as the host device 2A appropriately changes a combination of at least two transmission paths, a combination of delay amounts until a data signal is received by a flip-flop circuit changes, so that a variation is generated in a pattern of pass/fail information. In this way, since a malicious third party is forced to manufacture a counterfeit product capable of supporting pass/fail information having various change patterns, forgery difficulty of the memory device 3A is improved.

Further, in the present modification example, since one data signal (the first data signal A illustrated in FIG. 7A) is transmitted to the memory device 3A, an amount of data transmission can be reduced as compared with a case where a plurality of data signals (the first data signal A to the sixth data signal F in FIG. 6) are transmitted.

Here, the example in which one data signal is received by a flip-flop circuit via at least two of a plurality of transmission paths is described, but instead of this, the clock signal CLK may be received by a flip-flop circuit via at least two of a plurality of transmission paths. In this case, different numbers of buffers may be arranged on a plurality of transmission paths of the clock signal CLK.

### Modification Example 1-5

By changing drive capability of a memory device 3B, the host device 2B according to the present modification example performs authentication processing using a difference in delay time of data output from the memory device 3B between a genuine product and a counterfeit product.

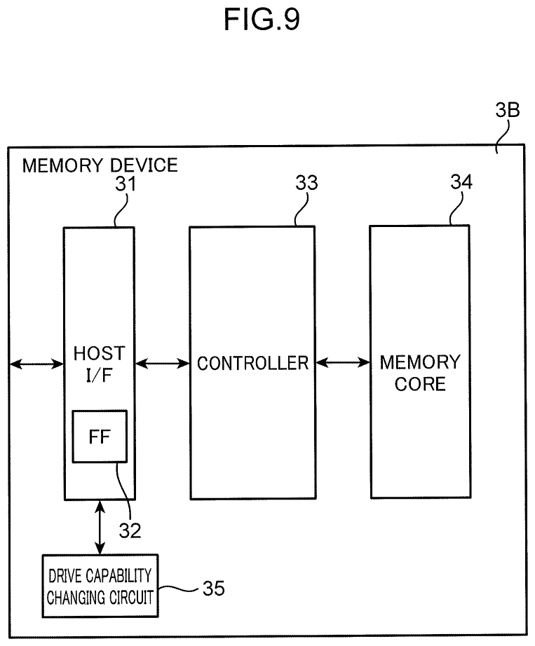

FIG. 9 is a diagram illustrating a configuration of the memory device 3B according to the present modification example in a simplified manner. The memory device 3B includes a second circuitry. As illustrated in FIG. 9, the second circuitry of the memory device 3B includes a drive capability changing circuit 35 (an example of a first capability changing circuit) that changes drive capability of the memory device 3B.

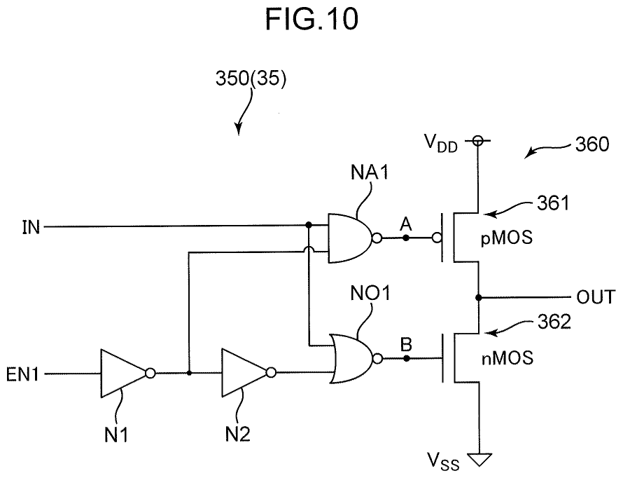

FIG. 10 is a diagram illustrating a configuration of a part of the drive capability changing circuit 35. The drive capability changing circuit 35 illustrated in FIG. 10 includes one tri-state circuit 350. The tri-state circuit 350 includes a first NAND gate NA1, a first NOT gate N1 and a second NOT gate N2, a first NOR gate NO1, and a first CMOS transistor 360. The first NAND gate NA1 includes an input terminal for receiving an input signal input to input IN and an input terminal for receiving output of the first NOT gate N1. The first NOT gate N1 includes an input terminal for receiving a first enable signal EN1. The second NOT gate N2 includes an input terminal for receiving output of the first NOT gate N1. The first NOR gate NO1 includes an input terminal for receiving an input signal input to the input IN and an input terminal for receiving output of the second NOT gate N2. The first CMOS transistor 360 includes a first pMOS transistor 361 arranged between power supply voltage VDD and output OUT, and a first nMOS transistor 362 arranged between the output OUT and ground VSS. A gate terminal of the first pMOS transistor 361 is connected to an output terminal of the first NAND gate NA1. A gate terminal of the first nMOS transistor 362 is connected to an output terminal of the first NOR gate NO1.

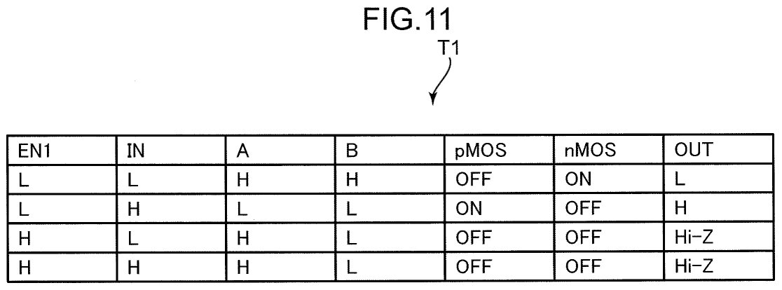

FIG. 11 illustrates a truth table T1 of the tri-state circuit 350 illustrated in FIG. 10. As illustrated in FIG. 11, in the tri-state circuit 350, when the first enable signal EN1 is valid (Low), an input signal input to the input IN is output to the output OUT. When the first enable signal EN1 is invalid (High), regardless of an input signal to the input IN, the output OUT enters a high impedance (Hi-Z) state in which current hardly flows.

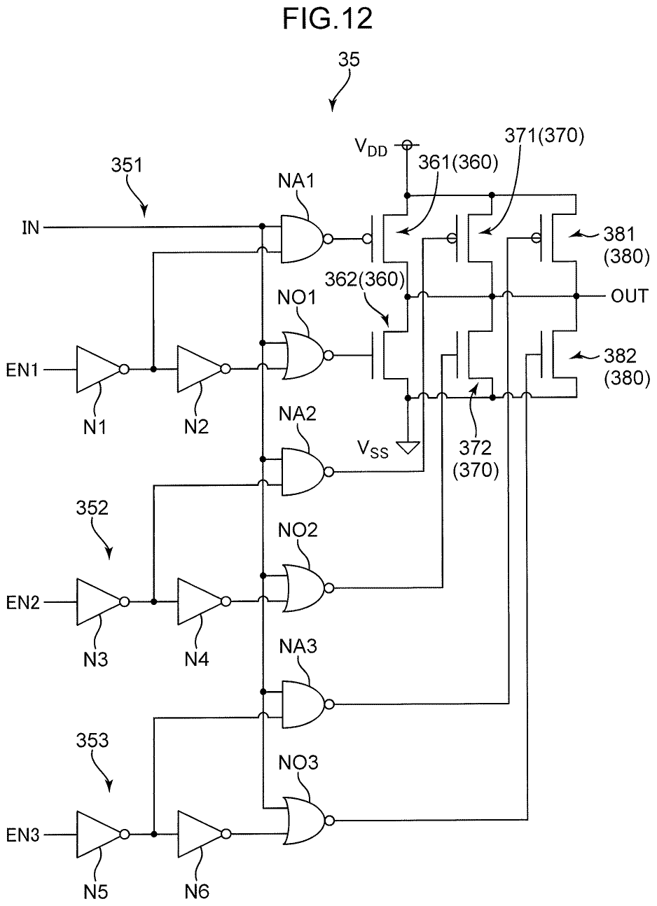

FIG. 12 is a diagram illustrating another example of the configuration of the drive capability changing circuit 35. The drive capability changing circuit 35 illustrated in FIG. 12 includes three tri-state circuits connected in parallel. For convenience of description, the three tri-state circuits are referred to as a first tri-state circuit 351, a second tri-state circuit 352, and a third tri-state circuit 353.

Since the first tri-state circuit 351 has the same configuration as the tri-state circuit 350 illustrated in FIG. 10, description of the first tri-state circuit 351 will be omitted.

The second tri-state circuit 352 includes a second NAND gate NA2, a third NOT gate N3 and a fourth NOT gate N4, a second NOR gate NO2, and a second CMOS transistor 370. The second NAND gate NA2 includes an input terminal for receiving an input signal input to the input IN and an input terminal for receiving output of the third NOT gate N3. The third NOT gate N3 includes an input terminal for receiving a second enable signal EN2. The fourth NOT gate N4 includes an input terminal for receiving output of the third NOT gate N3. The second NOR gate NO2 includes an input terminal for receiving an input signal input from the input IN and an input terminal for receiving output of the fourth NOT gate N4. The second CMOS transistor 370 includes a second pMOS transistor 371 arranged between the power supply voltage VDD and the output OUT, and a second nMOS transistor 372 arranged between the output OUT and the ground VSS. A gate terminal of the second pMOS transistor 371 is connected to an output terminal of the second NAND gate NA2. A gate terminal of the second nMOS transistor 372 is connected to an output terminal of the second NOR gate NO2.

The third tri-state circuit 353 includes a third NAND gate NA3, a fifth NOT gate N5 and a sixth NOT gate N6, a third NOR gate NO3, and a third CMOS transistor 380. The third NAND gate NA3 includes an input terminal for receiving an input signal input to the input IN and an input terminal for receiving output of the fifth NOT gate N5. The fifth NOT gate N5 includes an input terminal for receiving a third enable signal EN3. The sixth NOT gate N6 includes an input terminal for receiving output of the fifth NOT gate N5. The third NOR gate NO3 includes an input terminal for receiving an input signal input to the input IN and an input terminal for receiving output of the sixth NOT gate N6. The third CMOS transistor 380 includes a third pMOS transistor 381 arranged between the power supply voltage VDD and the output OUT, and a third nMOS transistor 382 arranged between the output OUT and the ground VSS. A gate terminal of the third pMOS transistor 381 is connected to an output terminal of the third NAND gate NA3. A gate terminal of the third nMOS transistor 382 is connected to an output terminal of the third NOR gate NO3.

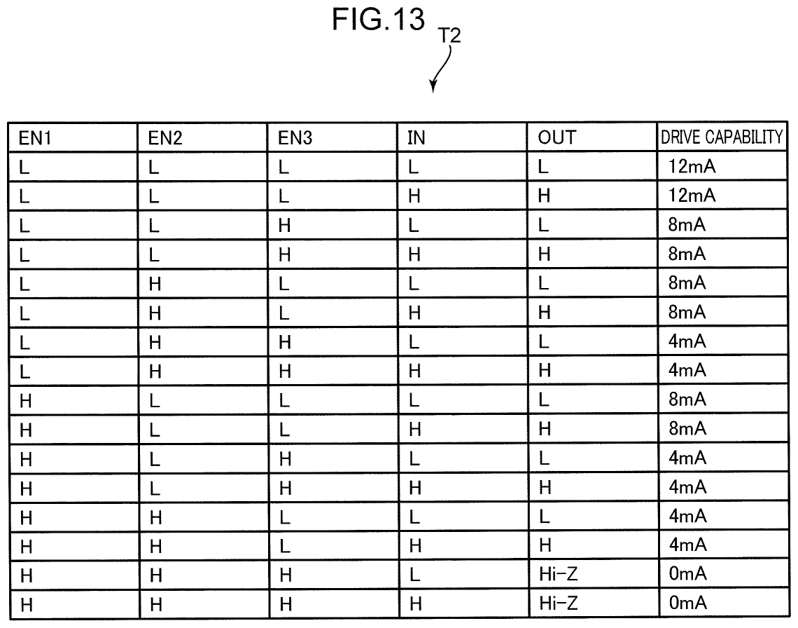

FIG. 13 illustrates a truth table T2 of the drive capability changing circuit 35 illustrated in FIG. 12. Assuming that current of 4 mA flows through each of the first CMOS transistor 360, the second CMOS transistor 370, and the third CMOS transistor 380, a value of current flowing to the output OUT changes depending on the number of CMOS transistors turned on by an enable signal EN.

In a case where one CMOS transistor is turned on, a value of current flowing to the output OUT is 4 mA (=1×4 mA). For example, in a case where the first enable signal EN1 is Low, the second enable signal EN2 is High, and the third enable signal EN3 is High, a value of current flowing to the output OUT is 4 mA. In this case, drive capability of the memory device 3B is set to 4 mA.

Further, in a case where two CMOS transistors are turned on, a value of current flowing to the output OUT is 8 mA (=2×4 mA). For example, in a case where the first enable signal EN1 is Low, the second enable signal EN2 is Low, and the third enable signal EN3 is High, a value of current flowing to the output OUT is 8 mA. In this case, drive capability of the memory device 3B is set to 8 mA.

In a case where three CMOS transistors are turned on, a value of current flowing to the output OUT is 12 mA (=3×4 mA). For example, in a case where the first enable signal EN1 is Low, the second enable signal EN2 is Low, and the third enable signal EN3 is Low, a value of current flowing to the output OUT is 12 mA. In this case, drive capability of the memory device 3B is set to 12 mA.

Further, for example, in a case where the first enable signal EN1 is High, the second enable signal EN2 is High, and the third enable signal EN3 is High, the output OUT is Hi-Z. In this case, drive capability of the memory device 3B is set to be equivalent to 0 mA.

Note that the drive capability changing circuit 35 illustrated in FIG. 12 is an example, and the number of tri-state circuits can be changed as appropriate. For example, the drive capability changing circuit 35 may include a fourth tri-state circuit, a fifth tri-state circuit, a sixth tri-state circuit, and the like in addition to the first tri-state circuit 351 to the third tri-state circuit 353 described above. The fourth tri-state circuit to the sixth tri-state circuit may have the same configuration as the second tri-state circuit 352 or the third tri-state circuit 353.

Further, the case where current of 4 mA flows through each of the first CMOS transistor 360, the second CMOS transistor 370, and the third CMOS transistor 380 is described as an example, but a value of current flowing through each CMOS circuit can be appropriately changed. For example, current of 2 mA may flow through each CMOS circuit.

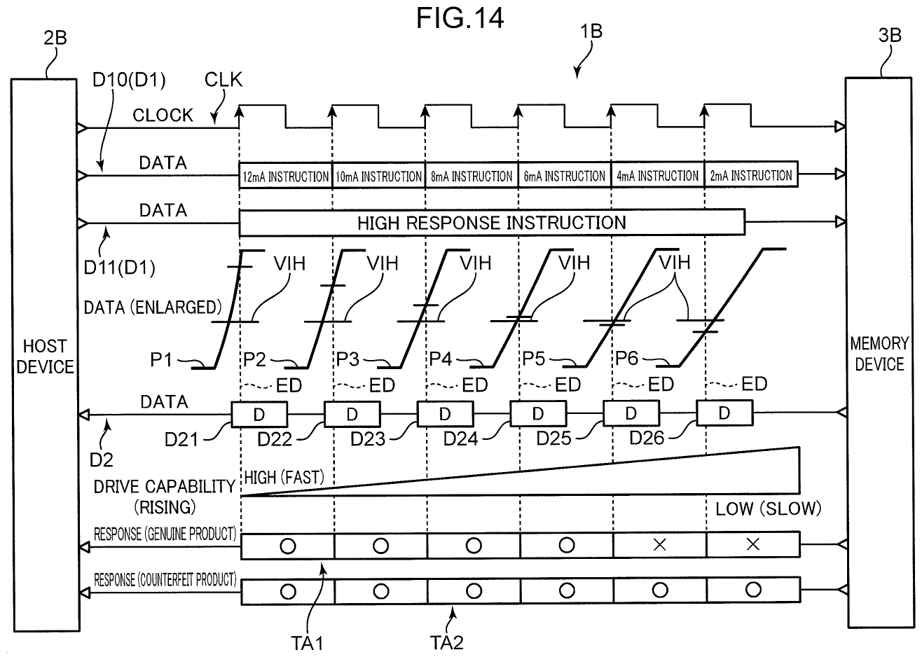

FIG. 14 is a diagram schematically illustrating data transmitted and received between the host device 2B and the memory device 3B in Modification Example 1-5. A flow of processing in an information processing system 1B according to Modification Example 1-5 will be described with reference to FIG. 14. Note that the memory device 3B includes the first tri-state circuit to the sixth tri-state circuit described above. Further, it is assumed that current of 2 mA flows through a CMOS circuit of each tri-state circuit.

First, the host device 2B transitions to the authentication phase at the time of startup or periodically.

Next, the test waveform generation circuit 23 of the host device 2B generates the clock signal CLK and the at least one of data signal D1. The at least one of data signal D1 generated by the test waveform generation circuit 23 according to the present modification example includes a first instruction signal D10 including an instruction to change drive capability of the memory device 3B and a second instruction signal D11 including an instruction to request transmission of a data signal to the host device 2B at a predetermined voltage level. In the example illustrated in FIG. 14, the first instruction signal D10 includes a first instruction to change drive capability of the memory device 3B to 12 mA, a second instruction to change the drive capability to 10 mA, a third instruction to change the drive capability to 8 mA, a fourth instruction to change the drive capability to 6 mA, a fifth instruction to change the drive capability to 4 mA, and a sixth instruction to change the drive capability to 2 mA. Note that, although detailed illustration is omitted, relative phase differences of the first instruction to the sixth instruction with respect to the clock signal CLK may be different from each other. Further, in the example illustrated in FIG. 14, the second instruction signal D11 includes an instruction (hereinafter referred to as “High response instruction”) to request transmission of a data signal to the host device 2B at a voltage level indicating High. The High response instruction includes, for example, address information indicating an address at which a data signal in which a voltage level indicates High is stored in the memory core 34, and an instruction for requesting transmission of a data signal stored at an address indicated by address information to the host device 2B.

Next, the host device 2B transmits the clock signal CLK, the first instruction signal D10, and the second instruction signal D11 to the memory device 3B via the command buffer 24, the data buffer 25, and the memory I/F 29.

The clock signal CLK and the first instruction signal D10 are received by the drive capability changing circuit 35 of the memory device 3B. The drive capability changing circuit 35 changes drive capability of the memory device 3B based on the first instruction signal D10. Further, the clock signal CLK and the second instruction signal D11 are received by the flip-flop circuit 32. The flip-flop circuit 32 sends a data signal (High response) in which a voltage level indicates High back to the host device 2B based on address information and an instruction included in the High response instruction. That is, the flip-flop circuit 32 transmits a data signal in which a voltage level indicates High to the host device 2B as the response data D2. In the example illustrated in FIG. 14, the response data D2 includes first response data D21 to sixth response data D26. The first response data D21 to the sixth response data D26 are response data transmitted to the host device 2B in a state where drive capability of the memory device 3B is set to 12 mA, 10 mA, 8 mA, 6 mA, 4 mA, and 2 mA. These pieces of response data are stored in the measurement value storage buffer 26 of the host device 2B.

A first pulse P1 illustrated in FIG. 14 indicates a state in which a signal of the first response data D21 rises from Low to High. Similarly, a second pulse P2 to a sixth pulse P6 also indicate states in which signals of the second response data D22 to the sixth response data D26 rise from Low to High, respectively. Note that the first pulse P1 to the sixth pulse P6 indicate pulses of the first response data D21 to the sixth response data D26 transmitted from the memory device 3B as a genuine product to the host device 2B. A broken line illustrated in FIG. 14 indicates the clock edge ED. A lower limit threshold VIH illustrated in FIG. 14 indicates a lower limit of a voltage level at which a data signal is determined to be High.

As illustrated in FIG. 14, at a time point of the clock edge ED, a voltage level of the first pulse P1 exceeds the lower limit threshold VIH. Similarly, in the second pulse P2 to the fourth pulse P4, a voltage level of each pulse exceeds the lower limit threshold VIH at a time point of the clock edge ED. For this reason, the host device 2B recognizes that the first response data D21 to the fourth response data D24 are data signals (hereinafter, referred to as High responses) in which a voltage level indicates High. On the other hand, in the fifth pulse P5 and the sixth pulse P6, a voltage level is lower than the lower limit threshold VIH at a time point of the clock edge ED. For this reason, the host device 2B recognizes that the fifth response data D25 and the sixth response data D26 are not the High responses.

A genuine product table TA1 of FIG. 14 is a table indicating whether or not each piece of the response data D2 transmitted from the memory device 3B as a genuine product to the host device 2B is the High response. “○” in the genuine product table TA1 indicates that the memory device 3B as a genuine product succeeds in transmitting the High response to the host device 2B. For this reason, “○” is assigned to fields corresponding to the first response data D21 to the fourth response data D24 in the genuine product table TA1. On the other hand, “×” indicates that the memory device 3B as a genuine product fails to transmit the High response to the host device 2B. Therefore, “×” is assigned to fields corresponding to the fifth response data D25 and the sixth response data D26 in the genuine product table TA1.

A counterfeit product table TA2 of FIG. 14 is a table indicating whether or not each piece of the response data D2 transmitted from the memory device 3B as a counterfeit product to the host device 2B is the High response. “○” indicates that the memory device 3B as a counterfeit product succeeds in transmitting the High response to the host device 2B. In general, a circuit corresponding to the drive capability changing circuit 35 is not mounted on the memory device 3B as a counterfeit product. For this reason, the memory device 3B as a counterfeit product transmits the response data D2 to the host device 2B with constant drive capability (for example, 8 mA) regardless of a drive capability change instruction (the first instruction signal D10). For this reason, even in a case where the first instruction signal D10 for which the High response cannot be transmitted by a genuine product is transmitted from the host device 2B to the memory device 3B, a counterfeit product transmits the High response to the host device 2B. For example, even in a case where an instruction to set drive capability to 4 mA or 2 mA is sent to the memory device 3B, the memory device 3B as a counterfeit product succeeds in transmitting the High response to the host device 2B as shown in fields corresponding to the fifth response data D25 and the sixth response data D26 in the counterfeit product table TA2. Alternatively, in a case where the first instruction signal D10 for which the High response can be transmitted by the memory device 3B as a genuine product is transmitted to a memory device 3B, it is also assumed that the memory device 3B as a counterfeit product transmits response data (hereinafter, referred to as Low response) in which a voltage level indicates Low to the host device 2B. As described above, by changing drive capability of the memory device 3B, voltage levels of the response data D2 can be made different between a genuine product and a counterfeit product.

Next, the expected value comparator 28 of the host device 2B compares the expected value data D3 in the expected value storage memory 27 with the response data D2 to determine whether or not the memory device 3B can transmit the response data D2 having a voltage level similar to a voltage level of the response data D2 that a genuine product sends back to the host device 2B. In a case where the expected value comparator 28 determines that the memory device 3B sends back the response data D2 having a voltage level similar to that of a genuine product, the host device 2B resumes the normal operation. On the other hand, in a case where the memory device 3B cannot send back the response data D2 having a voltage level similar to that of a genuine product, the host device 2B stops operation or performs re-authentication.

In the present modification example, an instruction to change drive capability of the memory device 3B is output to the memory device 3B. In a case where the memory device 3B is a genuine product, the memory device 3B transmits the response data D2 to the host device 2B in a state where drive capability is changed based on the first instruction signal D10. On the other hand, in a case where the memory device 3B is a counterfeit product, the response data D2 is transmitted to the host device 2B in a state where drive capability is fixed. For this reason, delay time of data output from the memory device 3B, that is, delay time of response data is different between a genuine product and a counterfeit product. As a result, a voltage level of the response data D2 is different between the genuine product and the counterfeit product. By using this difference, the expected value comparator 28 can more accurately identify whether the memory device 3B is a genuine product or a counterfeit product.

Note that the memory core 34 of the memory device 3B as a genuine product may store setting for transmitting the Low response to the host device 2B in a case of operation with predetermined drive capability. For example, the memory core 34 of the memory device 3B as a genuine product may store setting for transmitting the Low response to the host device 2B in a case where drive capability is set to 10 mA. In this way, in a case where the drive capability is set to 10 mA, the memory device 3B as a genuine product ignores the High response instruction and transmits the Low response to the host device 2B. On the other hand, the memory device 3B as a counterfeit product transmits the High response to the host device 2B based on the High response instruction. For this reason, content of the response data D2 is different between a genuine product and a counterfeit product. As a result, the expected value comparator 28 can easily identify whether a product is genuine or counterfeit.

Further, in Modification Example 1-5, the example in which the second instruction signal D11 includes an instruction to transmit a data signal in which a voltage level indicates High is described, but instead of this, the second instruction signal D11 may include an instruction to transmit a data signal in which a voltage level indicates Low.

### Modification Example 1-6

A host device 2C according to the present modification example performs authentication processing by using the fact that drive capability of a memory device 3C is different between a genuine product and a counterfeit product.

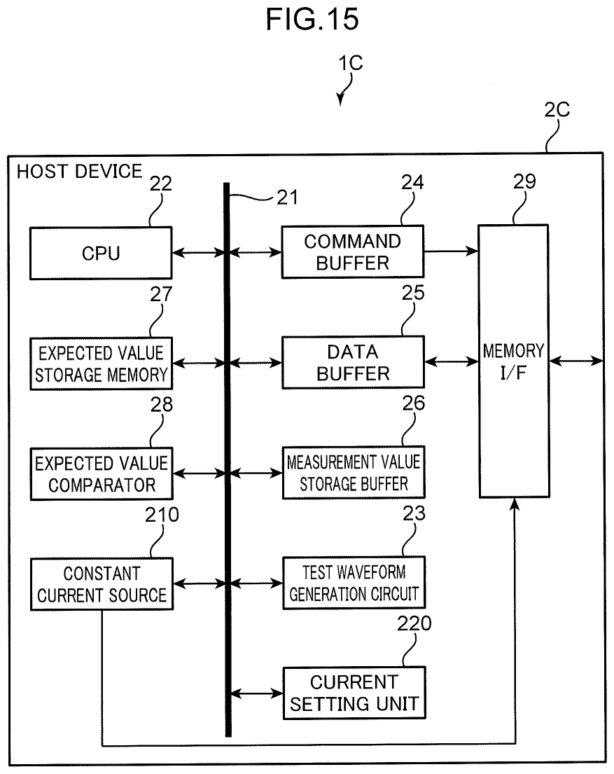

FIG. 15 is a diagram illustrating a configuration of the host device 2C according to the present modification example in a simplified manner. The host device 2C includes a first circuitry. The first circuitry of the host device 2C includes a constant current source 210. The constant current source 210 changes a logical value of the response data D2 by drawing constant current from the memory device 3C or sending constant current to the memory device 3C.

Since a configuration of the memory device 3C is similar to the configuration of the memory device 3B (FIG. 9) according to Modification Example 1-5, description of the configuration of the memory device 3C is omitted.

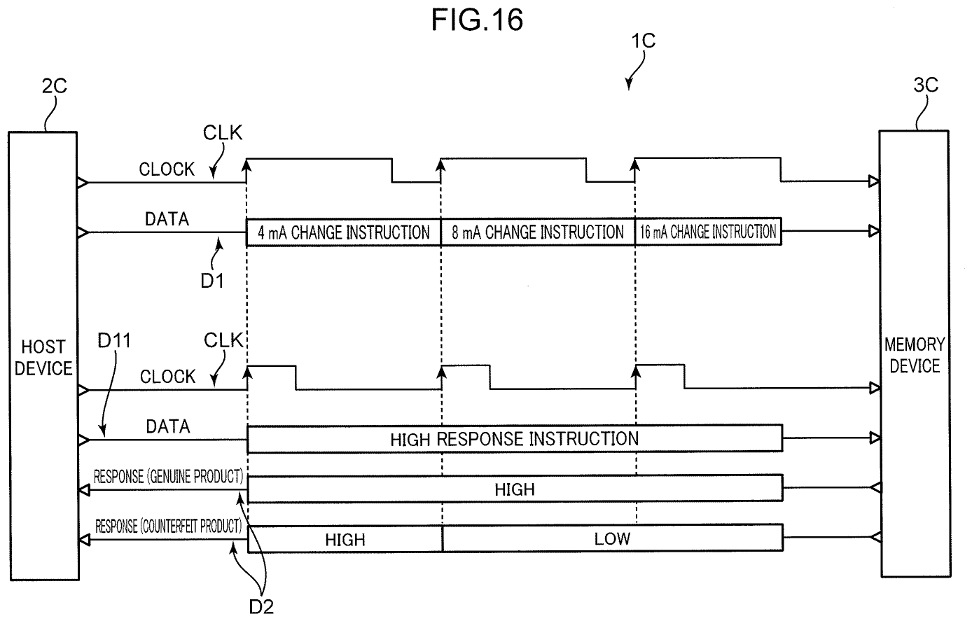

FIG. 16 is a diagram schematically illustrating data transmitted and received between the host device 2C and the memory device 3C in Modification Example 1-6. A flow of processing in an information processing system 1C according to Modification Example 1-6 will be described with reference to FIG. 16.

First, the host device 2C transitions to the authentication phase at the time of startup or periodically.

Next, the test waveform generation circuit 23 of the host device 2C generates the clock signal CLK and a first instruction signal for changing drive capability of the memory device 3C. In the example illustrated in FIG. 16, the first instruction signal includes a first instruction to change drive capability of the memory device 3C to 4 mA, a second instruction to change drive capability of the memory device 3C to 8 mA, and a third instruction to change drive capability of the memory device 3C to 12 mA. Although detailed illustration is omitted, relative phase differences of the first instruction to the third instruction with respect to the clock signal CLK may be different from each other.

Next, the host device 2C transmits the clock signal CLK and the first instruction signal to the memory device 3C via the command buffer 24, the data buffer 25, and the memory I/F 29.

Next, a current setting unit 220 included in the first circuitry of the host device 2C sets a current value of sink current generated by the constant current source 210 pulling current from the memory device 3C or source current generated by the constant current source 210 pushing current into the memory device 3C.

Next, the test waveform generation circuit 23 of the host device 2C generates the clock signal CLK and the second instruction signal D11 for drive capability verification. In the example illustrated in FIG. 16, the second instruction signal D11 includes the High response instruction. The High response instruction includes, for example, address information indicating an address at which a data signal in which a voltage level indicates High is stored in the memory core 34, and an instruction for requesting transmission of a data signal stored at an address indicated by address information to the host device 2C.

Next, the host device 2C transmits the clock signal CLK and the second instruction signal D11 to the memory device 3C via the command buffer 24, the data buffer 25, and the memory I/F 29.

Next, the memory device 3C inputs the first instruction signal to the drive capability changing circuit 35. The drive capability changing circuit 35 changes drive capability of the memory device 3C based on the first instruction signal. Further, the second instruction signal D11 is received by the flip-flop circuit 32 of the host I/F 31. The flip-flop circuit 32 sends a data signal (High response) in which a voltage level indicates High back to the host device 2C based on address information and an instruction included in the High response instruction.

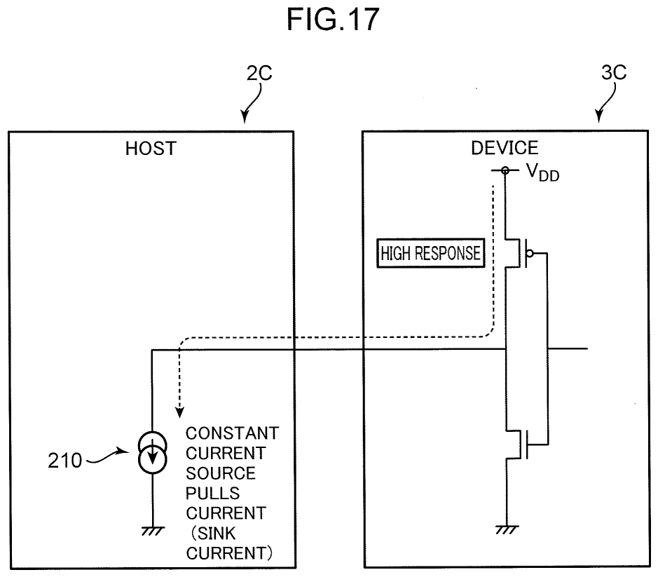

FIG. 17 is a diagram schematically illustrating current flowing from the memory device 3C to the constant current source 210 in a case where the High response instruction is transmitted from the host device 2C to the memory device 3C. In a case where the High response instruction is sent to the memory device 3C, the constant current source 210 according to the present modification example performs an operation of drawing (pulling) current from the memory device 3C. By this, sink current is generated. When sink current becomes larger than drive capability of the memory device 3C, voltage drop in a pMOS circuit of the memory device 3C becomes large, and the memory device 3C cannot maintain the High response. Specifically, a voltage level of the response data D2 output from the memory device 3C falls below the lower limit threshold VIH, and by this, the host device 2C cannot recognize the response data D2 as the High response.

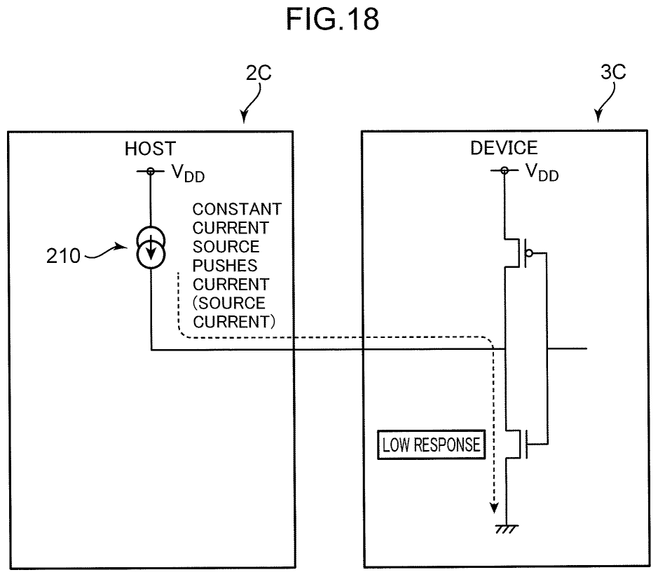

FIG. 18 is a diagram schematically illustrating current sent from the constant current source 210 to the memory device 3C in a case where an instruction (Low response instruction) to transmit a data signal in which a voltage level indicates Low is transmitted from the host device 2C to the memory device 3C. In a case where a Low response instruction is sent to the memory device 3C, the constant current source 210 according to the present modification example performs an operation of pushing (sending) current to the memory device 3C. By this, source current is generated. When source current becomes larger than drive capability of the memory device 3C, voltage rise in an nMOS circuit of the memory device 3C becomes large, and the memory device 3C cannot maintain the Low response. Specifically, a voltage level of the response data D2 output from the memory device 3C exceeds an upper limit threshold VIL, which is an upper limit to be recognized as a Low signal, and, by this, the host device 2C cannot recognize the response data D2 as the Low response.

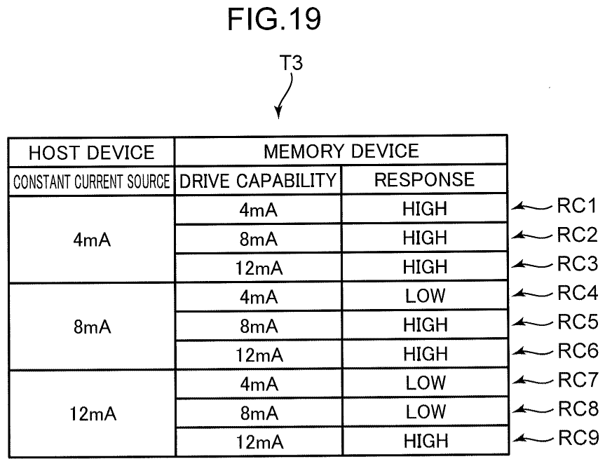

FIG. 19 illustrates a table T3 for explaining a relationship between setting of a current value of current (sink current) drawn by the constant current source 210, setting of drive capability of the memory device 3C, and a voltage level of the response data D2. In a case where memory device 3C is a genuine product, the response data D2 having a voltage level shown in an item of “Response” in FIG. 19 is transmitted to host device 2C.

For example, as illustrated in a first record RC1 to a third record RC3 of FIG. 19, in a case where a current value of current (sink current) drawn from the memory device 3C by the constant current source 210 is set to 4 mA and drive capability of the memory device 3C is set to 4 mA, 8 mA, or 12 mA, the response data D2 transmitted by the flip-flop circuit 32 is received by the host device 2C as the High response.

Further, as illustrated in a fourth record RC4, in a case where a current value of sink current is set to 8 mA and drive capability of the memory device 3C is set to 4 mA, the response data D2 transmitted by the flip-flop circuit 32 is received by the host device 2C as the Low response. On the other hand, as illustrated in a fifth record RC5 and a sixth record RC6, in a case where a current value of sink current is set to 8 mA and drive capability of the memory device 3C is set to 8 mA or 12 mA, the response data D2 transmitted by the flip-flop circuit 32 is received by the host device 2C as the High response.

Further, as illustrated in a seventh record RC7 and an eighth record RC8 of FIG. 19, in a case where a current value of sink current is set to 12 mA and drive capability of the memory device 3C is set to 4 mA or 8 mA, the response data D2 transmitted by the flip-flop circuit 32 is received by the host device 2C as the Low response. On the other hand, as illustrated in a ninth record RC9, in a case where a current value of sink current is set to 12 mA and drive capability of the memory device 3C is set to 12 mA, the response data D2 transmitted by the flip-flop circuit 32 is received by the host device 2C as the High response.

As described above, when the host device 2C transmits the High response instruction to the memory device 3C in a state where a current value of sink current is set higher than drive capability of the memory device 3C, response data transmitted from the memory device 3C is received by the host device 2C as the Low response. The information processing system 1C according to the present modification example uses this characteristic to determine whether the memory device 3C is a genuine product or a counterfeit product.

Drive capability of the memory device 3C as a counterfeit product is often fixed. That is, a circuit corresponding to the drive capability changing circuit 35 is not provided in many cases. As an example, a case where drive capability of the memory device 3C as a counterfeit product is fixed to 8 mA, and drive capability of the memory device 3C as a genuine product is variable according to the first instruction signal is assumed. Here, it is assumed that a current value of sink current is set to 12 mA, and the host device 2C transmits, to the memory device 3C, a first instruction signal for setting drive capability of the memory device 3C to 12 mA. In this case, the drive capability of the memory device 3C as a genuine product is set to 12 mA, but drive capability of a counterfeit product remains fixed to 8 mA. In this state, when the host device 2C transmits the High response instruction to the memory device 3C, if the memory device 3C is a genuine product, the memory device 3C transmits the High response to the host device 2C, but the memory device 3C as a counterfeit product cannot maintain the High response, and transmits the Low response to the host device 2C. As described above, content of the response data D2 is different between the memory device 3C as a genuine product and the memory device 3C as a counterfeit product.

Referring again to FIG. 16, the memory I/F 29 of the host device 2C receives the response data D2 from the memory device 3C, and stores the response data D2 in the measurement value storage buffer 26.

Next, the expected value comparator 28 of the host device 2C compares the expected value data D3 stored in the expected value storage memory 27 with the response data D2 stored in the measurement value storage buffer 26. In a case where the expected value comparator 28 determines that the expected value data D3 matches the response data D2, the host device 2C resumes the normal operation. Further, in a case where the expected value comparator 28 determines that the expected value data D3 and the response data D2 do not match, operation of the host device 2C is stopped, or re-authentication or the like is performed.

According to the present modification example, when a current value of current (sink current) drawn from the memory device 3C by the constant current source 210 and drive capability of the memory device 3C are set to a predetermined combination, it is possible to check whether or not the memory device 3C transmits the response data D2 at an appropriate voltage level. In a case of receiving the response data D2 at an appropriate voltage level from the memory device 3C, the expected value comparator 28 determines that the memory device 3C is a genuine product. On the other hand, in a case where the response data D2 at an appropriate voltage level is not received, it is determined that the memory device 3C is a counterfeit product. In this way, the host device 2C can accurately identify whether or not the memory device 3C is a genuine product.

In Modification Example 1-6, the example in which the High response instruction is transmitted from the host device 2C to the memory device 3C is described, but instead of this, the host device 2C may transmit the Low response instruction to the memory device 3C. In this case, description of “High” and “Low” in the item of “Response” in the table of FIG. 19 is reversed.

### Modification Example 1-7

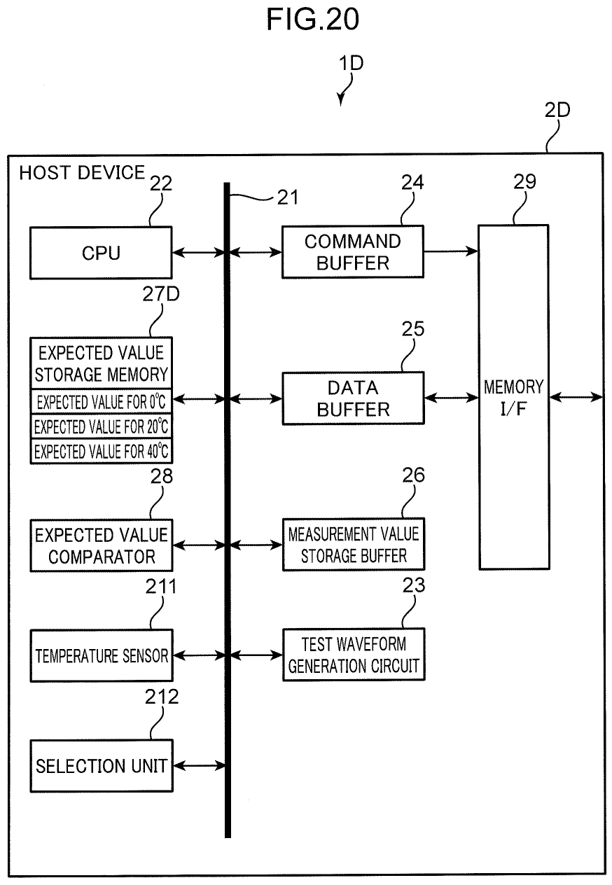

An information processing system 1D according to the present modification example stores the expected value data D3 for each temperature in the expected value storage memory 27, and switches the expected value data D3 according to an ambient temperature measured by a temperature sensor 211. FIG. 20 is a diagram illustrating a configuration of a host device 2D according to Modification Example 1-7 in a simplified manner. The host device 2D includes a first circuitry. The first circuitry of the host device 2D includes a temperature sensor 211 and a selection unit 212.

The temperature sensor 211 (an example of a temperature measurement unit) measures an ambient temperature of the host device 2D. The temperature sensor 211 measures, for example, a circuit board temperature of the host device 2D as an ambient temperature. Further, the temperature sensor 211 may measure atmospheric temperature around the host device 2D as an ambient temperature. Since the host device 2D is connected to a memory device (not illustrated) and heat is conducted through a connection portion, a circuit board temperature of the host device 2D and a circuit board temperature of the memory device are close to each other. Further, since the host device 2D and the memory device are connected and are in the same space, atmospheric temperature around the host device 2D is close to atmospheric temperature around the memory device. That is, an ambient temperature of the memory device can be indirectly measured by measuring an ambient temperature of the host device 2D. Note that in a case where the temperature sensor is provided in the same IC chip as other circuits included in the host device 2D, the temperature sensor may measure a temperature inside a die or a surface of an IC.

An expected value storage memory 27D (an example of a storage circuit) of the host device 2D stores a plurality of pieces of the expected value data D3. Specifically, a correspondence relationship between an ambient temperature of the host device 2D and a plurality of pieces of the expected value data D3 is stored. For example, first expected value data corresponding to a case where an ambient temperature is 0° C., second expected value data corresponding to a case where an ambient temperature is 20° C., third expected value data corresponding to a case where an ambient temperature is 40° C., and the like are stored in the expected value storage memory 27D. Note that, in FIG. 20, the first expected value data is described as an expected value for 0° C., the second expected value data is described as an expected value for 20° C., and the third expected value data is described as expected value data for 40° C. However, these pieces of expected value data are merely examples, and more expected value data may be stored in the expected value storage memory 27D. Further, the expected value storage memory 27D may store a correspondence relationship between a temperature range and an expected value. For example, fourth expected value data corresponding to a case where an ambient temperature is in a range higher than 0° C. and lower than 20° C. may be stored.

The selection unit 212 selects an expected value of any one of a plurality of pieces of the expected value data D3 as specific data. Specifically, the selection unit 212 according to the present modification example selects the expected value data D3 corresponding to a temperature measured by the temperature sensor 211 as the specific data. For example, the selection unit 212 selects the first expected value data as the specific data in a case where the ambient temperature is 0° C., and selects the second expected value data as the specific data in a case where the ambient temperature is 20° C.

The expected value comparator 28 according to the present modification example determines whether or not a memory device is a genuine product based on the specific data and the response data D2.

According to the present modification example, accuracy of determination (authenticity determination) as to whether a memory device is a genuine product is improved. Specifically, due to influence of ambient temperature of a memory device, performance or the like of the memory device may change, and as a result, content of the response data D2 may slightly change. Here, in the present modification example, an ambient temperature of a memory device is indirectly measured by measuring an ambient temperature of the host device 2D. Then, based on a measurement result of the ambient temperature, expected value data (specific data) used for comparison with response data is switched. In this way, it is possible to cope with a change in content of the response data D2 due to influence of ambient temperature of a memory device. For this reason, accuracy of determination (authenticity determination) as to whether a memory device is a genuine product is improved.

### Modification Example 1-8

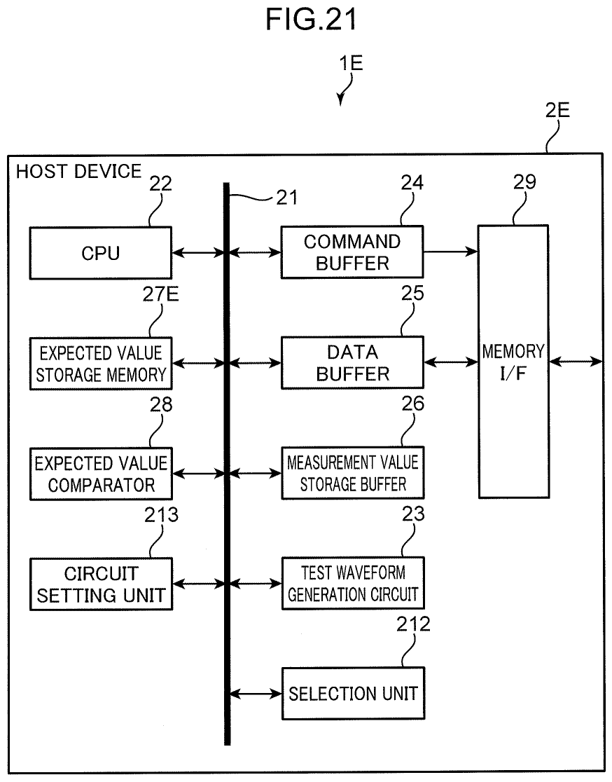

An information processing system 1E according to the present modification example performs authenticity determination by selectively using an internal circuit. That is, difficulty of forgery is improved by using a different setup/hold time characteristic for each internal circuit. FIG. 21 is a diagram illustrating a configuration of a host device 2E according to Modification Example 1-8 in a simplified manner. The host device 2E includes a first circuitry. The first circuitry of the host device 2E includes a circuit setting unit 213 and the selection unit 212.

The circuit setting unit 213 sets an internal circuit used for authentication as to whether the memory device 3E is a genuine product or a counterfeit product. Specifically, the circuit setting unit 213 according to the present modification example sets at least one of a first combinational circuit 411, a second combinational circuit 412, and a third combinational circuit 413 to be described later as an internal circuit to be used for authentication. The at least one of data signal D1 is input to a flip-flop circuit via a combinational circuit set by the circuit setting unit 213. The test waveform generation circuit 23 according to the present modification example generates a circuit selection signal indicating a combinational circuit set by the circuit setting unit 213.

An expected value storage memory 27E of the host device 2E stores a plurality of pieces of the expected value data D3. Specifically, a correspondence relationship between a combinational circuit used for authentication and a plurality of pieces of the expected value data D3 is stored. For example, fifth expected value data corresponding to a case where the first combinational circuit 411 to be described later is set as an internal circuit used for authentication, sixth expected value data corresponding to a case where the second combinational circuit 412 to be described later is set as an internal circuit used for authentication, seventh expected value data corresponding to a case where the third combinational circuit 413 to be described later is set as an internal circuit used for authentication, and the like are stored in the expected value storage memory 27E. In addition, expected value data corresponding to each of a case where the first combinational circuit 411 and the second combinational circuit 412 are set as internal circuits used for authentication, a case where the first combinational circuit 411 and the third combinational circuit 413 are set as internal circuits used for authentication, a case where the second combinational circuit 412 and the third combinational circuit 413 are set as internal circuits used for authentication, and a case where the first combinational circuit 411, the second combinational circuit 412, and the third combinational circuit 413 are set as internal circuits used for authentication is stored in the expected value storage memory 27E.

The selection unit 212 selects the expected value data D3 corresponding to a combinational circuit set by the circuit setting unit 213 as specific data. For example, in a case where the circuit setting unit 213 sets the first combinational circuit 411 as an internal circuit used for authentication, the fifth expected value data described above is selected as the specific data.

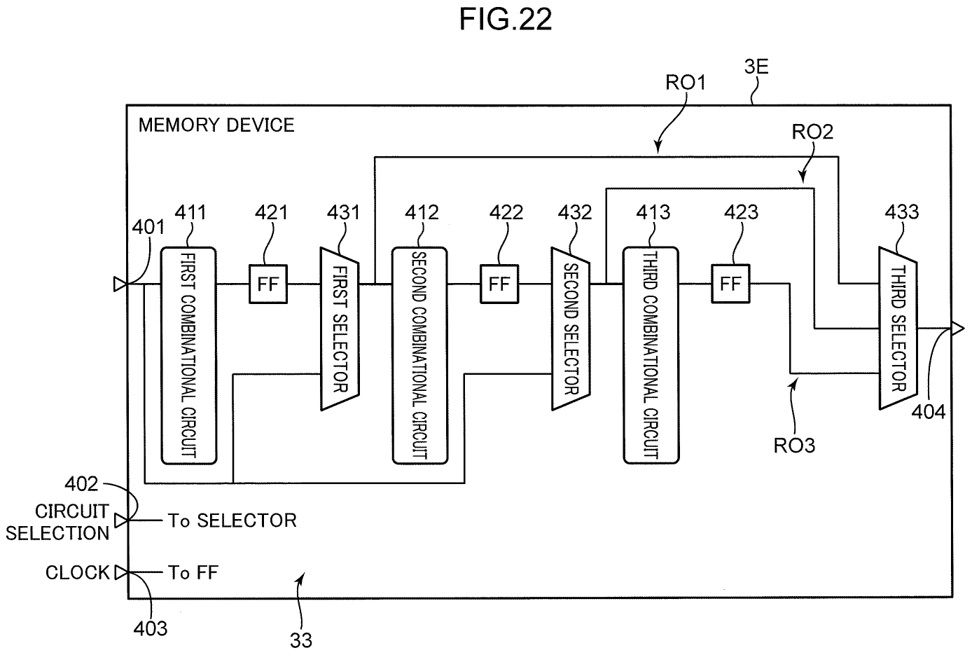

FIG. 22 is a diagram illustrating an internal configuration of the controller 33 of a second circuitry included in the memory device 3E according to the present modification example in a simplified manner. As illustrated in FIG. 22, the controller 33 of the memory device 3E includes a data signal input unit 401, a circuit selection signal input unit 402, a clock signal input unit 403, a data output unit 404, the first combinational circuit 411, the second combinational circuit 412, the third combinational circuit 413, a first flip-flop circuit 421, a second flip-flop circuit 422, a third flip-flop circuit 423, a first selector 431, a second selector 432, and a third selector 433. Each of the first selector 431 and the second selector 432 has a first input terminal and a second input terminal in order from the top in the diagram. The third selector 433 includes a first input terminal, a second input terminal, and a third input terminal in this order from the top in the diagram.

The at least one of data signal D1 received by the flip-flop circuit 32 of the host I/F 31 is input to the data signal input unit 401.

A circuit selection signal received by the host I/F 31 of the memory device 3E is input to the circuit selection signal input unit 402. The circuit selection signal input to the circuit selection signal input unit 402 is input to each of the selectors 431, 432, and 433 via a predetermined transmission path (not illustrated). Each of the selectors 431, 432, and 433 operates based on a circuit selection signal to switch a transmission path of the at least one of data signal D1.

For example, in a case where a circuit selection signal indicating that the first combinational circuit 411 is used for authentication is input to the circuit selection signal input unit 402, both the first selector 431 and the third selector 433 select the first input terminal, so that a first path RO1 illustrated in FIG. 22 becomes a transmission path. For example, in a case where a circuit selection signal indicating that the second combinational circuit 412 is used for authentication is input to the circuit selection signal input unit 402, the first selector 431 selects the second input terminal, the second selector 432 selects the first input terminal, and the third selector 433 selects the second input terminal, so that a second path RO2 becomes a transmission path. In a case where a circuit selection signal indicating that the third combinational circuit 413 is used for authentication is input to the circuit selection signal input unit 402, the second selector 432 selects the second input terminal, and the third selector 433 selects the third input terminal, so that a third path RO3 becomes a transmission path.

The first path RO1 is a path through which the at least one of data signal D1 is output from the data output unit 404 via the first combinational circuit 411, the first flip-flop circuit 421, the first selector 431, and the third selector 433. The second path RO2 is a path through which the at least one of data signal D1 is output from the data output unit 404 via the first selector 431, the second combinational circuit 412, the second flip-flop circuit 422, the second selector 432, and the third selector 433. The third path RO3 is a path through which the at least one of data signal D1 is output from the data output unit 404 via the second selector 432, the third combinational circuit 413, the third flip-flop circuit 423, and the third selector 433.

The clock signal CLK received by the flip-flop circuit 32 of the host I/F 31 is input to the clock signal input unit 403. The clock signal CLK is input to the first flip-flop circuit 421, the second flip-flop circuit 422, and the third flip-flop circuit 423 via a clock line (not illustrated).

In a case where a circuit selection signal indicating that the first combinational circuit 411 is used for authentication is input, the first combinational circuit 411 receives the at least one of data signal D1 input from the data signal input unit 401. The first combinational circuit 411 outputs the at least one of data signal D1 to the first flip-flop circuit 421. The first flip-flop circuit 421 outputs the at least one of data signal D1 to the first selector 431. The first selector 431 outputs the at least one of data signal D1 input from the first flip-flop circuit 421 to the third selector 433.

In a case where a circuit selection signal indicating that the second combinational circuit 412 is used for authentication is input, the second combinational circuit 412 receives the at least one of data signal D1 input from the data signal input unit 401 to the first selector 431 and output from the first selector 431. The second combinational circuit 412 outputs the at least one of data signal D1 to the second flip-flop circuit 422. The second flip-flop circuit 422 outputs the at least one of data signal D1 to the second selector 432. The second selector 432 outputs the at least one of data signal D1 input from the second flip-flop circuit 422 to the third selector 433.

In a case where a circuit selection signal indicating that the third combinational circuit 413 is used for authentication is input, the third combinational circuit 413 receives the at least one of data signal D1 input from the data signal input unit 401 to the second selector 432 and output from the second selector 432. The third combinational circuit 413 outputs the at least one of data signal D1 to the third flip-flop circuit 423. The third flip-flop circuit 423 outputs the at least one of data signal D1 to the third selector 433.

Since delay time is different in each of the first combinational circuit 411, the second combinational circuit 412, and the third combinational circuit 413, when the first selector 431 to the third selector 433 operate to switch a transmission path (critical path) of the at least one of data signal D1, time until the at least one of data signal D1 is input to a flip-flop circuit changes. That is, a setup/hold time characteristic is switched depending on which combinational circuit is used for authentication.

Processing of the information processing system 1E according to the present modification example will be described.

First, the host device 2E transitions to the authentication phase at the time of startup or periodically.

Next, the circuit setting unit 213 of the host device 2E sets a combinational circuit used for authentication as to whether the memory device 3E is a genuine product or a counterfeit product. For example, the circuit setting unit 213 sets the second combinational circuit 412 of the memory device 3E to be used for authentication.

Next, the test waveform generation circuit 23 of the host device 2E generates the clock signal CLK, the at least one of data signal D1, and a circuit selection signal. The test waveform generation circuit 23 generates, for example, a plurality of data signals having different relative phase differences with respect to the clock signal CLK as the at least one of data signal D1. Further, in this example, the test waveform generation circuit 23 generates a circuit selection signal indicating that the second combinational circuit 412 is used for authentication.

Next, the host device 2E transmits the clock signal CLK, a plurality of the data signals, and the circuit selection signal to the memory device 3E via the command buffer 24, the data buffer 25, and the memory I/F 29.

Next, the first selector 431 to the third selector 433 of the memory device 3E switch a transmission path (critical path of a plurality of data signals) through which a plurality of the data signals pass based on the circuit selection signal. In this example, since the circuit selection signal indicating that the second combinational circuit 412 is used for authentication is transmitted from the host device 2E, a plurality of the data signals are input to the second combinational circuit 412 via the data signal input unit 401 and the first selector 431. Then, a plurality of the data signals output from the second combinational circuit 412 are input to the second flip-flop circuit 422. A plurality of the data signals read by the second flip-flop circuit 422 are sent back to the host device 2E as the response data D2.

Next, the host device 2E receives the response data D2 from the memory device 3E, and stores the response data D2 in the measurement value storage buffer 26.

Then, the expected value comparator 28 of the host device 2E compares the response data D2 with the expected value data D3 (specific data) corresponding to the combinational circuit used for authentication to determine whether the memory device 3E is a genuine product.

According to the present modification example, the expected value data D3 referred to by the expected value comparator 28 is switched according to setting of the circuit setting unit 213. In this way, since a malicious third party is forced to manufacture a memory device capable of generating the response data D2 that can correspond to the expected value data D3 switched according to setting of the circuit setting unit 213, forgery difficulty of the memory device 3E is improved. In particular, if a combinational circuit used for authentication is appropriately changed while relative phase differences of a plurality of the data signals with respect to the clock signal CLK are adjusted, the number of patterns of pass/fail information becomes enormous, and thus forgery difficulty of the memory device 3E is further improved.

Moreover, in this modification, the response data D2 is transmitted to the host device 2E using not only the flip-flop circuit 32 disposed in an outer-side region within the memory device 3E (the host I/F 31) but also at least one of the first flip-flop circuit 421, the second flip-flop circuit 422, and the third flip-flop circuit 423 disposed in an inner-side region within the memory device 3E (the controller 33). For this reason, analysis difficulty of the response data D2 is improved.

Note that although the example in which the at least one of data signal D1 is input to any one of the first combinational circuit 411, the second combinational circuit 412, and the third combinational circuit 413 is described here, the at least one of data signal D1 may be input to two or more combinational circuits. In this case, data in a flip-flop circuit may be sequentially output from a selector (the third selector 433) of final output. For example, it is assumed that the at least one of data signal D1 is input to the first combinational circuit 411 and the third combinational circuit 413. In this case, the memory device 3E may be operated in such a flow that the at least one of data signal D1 is input to the data signal input unit 401, the first flip-flop circuit 421 and the third flip-flop circuit 423 are updated, the first flip-flop circuit 421 is caused to output data, the third flip-flop circuit 423 is caused to output data, and two pieces of the data output from the first flip-flop circuit 421 and the third flip-flop circuit 423 are transmitted to the host device 2E as the response data D2.

As described above, by selecting a plurality of combinational circuits, the number of data inputs can be reduced to one as compared with a case where each internal circuit is sequentially authenticated. For example, in a case where three types of the combinational circuits 411, 412, and 413 are sequentially authenticated, data input is required in each of the combinational circuits, and thus the number of data inputs is three, but in a case where three types of combinational circuits are simultaneously authenticated, the number of data inputs is one.

Note that in order to realize the present modification example, it is necessary to control a drive timing of a flip-flop circuit from the outside, and thus the present modification example can be applied to a case where a clock signal input from the outside is used in an internal circuit.

### Modification Example 1-9

An information processing system 1F according to the present modification example uses a scan circuit (test circuit) to authenticate whether or not the memory device 3F is a genuine product.

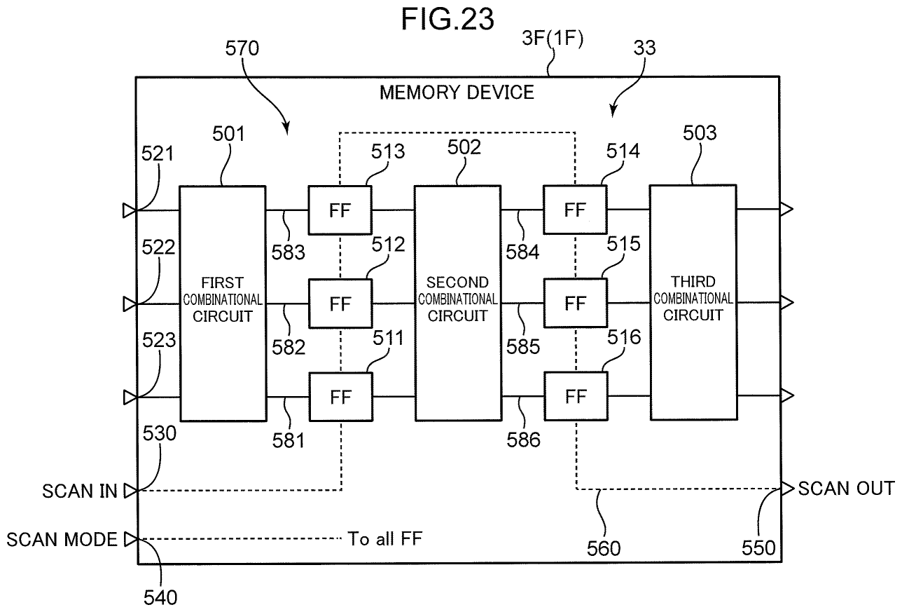

FIG. 23 is a diagram illustrating an internal configuration of the controller 33 included in a second circuitry of the memory device 3F according to the present modification example in a simplified manner. As illustrated in FIG. 23, the controller 33 includes a plurality of combinational circuits, a flip-flop circuit arranged in each of a plurality of connection paths connecting a plurality of the combinational circuits, a plurality of input interfaces, a scan-in terminal 530, a scan mode switching signal input terminal 540, and a scan-out terminal 550. A plurality of combinational circuits includes a first combinational circuit 501, a second combinational circuit 502, and a third combinational circuit 503. A plurality of connection paths connecting a plurality of combinational circuits include a first connection path 581 to a sixth connection path 586. A first flip-flop circuit 511 is arranged in the first connection path 581, a second flip-flop circuit 512 is arranged in the second connection path 582, a third flip-flop circuit 513 is arranged in the third connection path 583, a fourth flip-flop circuit 514 is arranged in the fourth connection path 584, a fifth flip-flop circuit 515 is arranged in the fifth connection path 585, and a sixth flip-flop circuit 516 is arranged in the sixth connection path 586. A plurality of input interfaces include a first input interface 521, a second input interface 522, and a third input interface 523. Further, the controller 33 includes a scan connection path 560 that serially connects the first flip-flop circuit 511 to the sixth flip-flop circuit 516. In the present modification example, a scan circuit 570 is formed by connecting each flip-flop circuit by the scan connection path 560. The memory device 3F transmits the response data D2 generated using the scan circuit 570 to a host device (not illustrated).

Processing of the information processing system 1F according to the present modification example will be described.

First, a host device (not illustrated) transitions to the authentication phase at the time of startup or periodically.

Next, the host device transmits a signal including an instruction to turn on a scan mode to the memory device 3F. When this signal is input to the scan mode switching signal input terminal 540 (FIG. 23), a scan mode of the scan circuit 570 is switched on.

Next, the test waveform generation circuit 23 of the host device generates at least one data signal D51 and the clock signal CLK for scan circuit verification. The test waveform generation circuit 23 according to the present modification example generates a plurality of data signals (hereinafter referred to as first plurality of data signals) having different relative phase differences with respect to the clock signal CLK as the at least one data signal D51.

Next, the host device transmits the clock signal CLK and the first plurality of data signals to the memory device 3F via the command buffer 24, the data buffer 25, and the memory I/F 29. These signals are input to the scan-in terminal 530 of the controller 33 via the flip-flop circuit 32 of the host I/F 31.

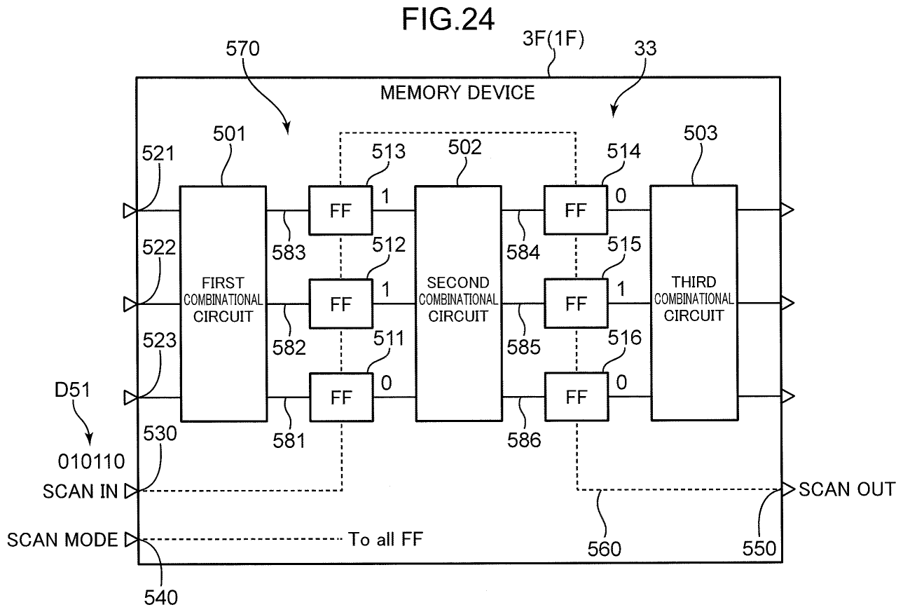

FIG. 24 is a diagram illustrating a state in which a predetermined value is set in each flip-flop circuit of the scan circuit 570. Specifically, in the example illustrated in FIG. 24, the first plurality of data signals are input (shifted in) from the scan-in terminal 530 in the order of 0, 1, 0, 1, 1, and 0. As a result, “0” is set to the first flip-flop circuit 511, “1” is set to the second flip-flop circuit 512, “1” is set to the third flip-flop circuit 513, “0” is set to the fourth flip-flop circuit 514, “1” is set to the fifth flip-flop circuit 515, and “0” is set to the sixth flip-flop circuit 516.

Next, the host device transmits a signal including an instruction to turn off the scan mode to the memory device 3F. When this signal is input to the scan mode switching signal input terminal 540 (FIG. 23), the scan mode of the scan circuit 570 is switched off.

Next, the test waveform generation circuit 23 of the host device generates at least one data signal D52 and the clock signal CLK for updating a flip-flop circuit. The test waveform generation circuit 23 according to the present modification example generates a plurality of data signals (hereinafter referred to as second plurality of data signals) having different relative phase differences with respect to the clock signal CLK as the at least one data signal D52.

Next, the host device transmits the clock signal CLK and the second plurality of data signals to the memory device 3F via the command buffer 24, the data buffer 25, and the memory I/F 29. These signals are input to a plurality of the input interfaces 521, 522, and 523 of the controller 33 via the flip-flop circuit 32 of the host I/F 31. By this, the memory device 3F operates a plurality of combinational circuits of the controller 33 and updates states of a plurality of flip-flop circuits.

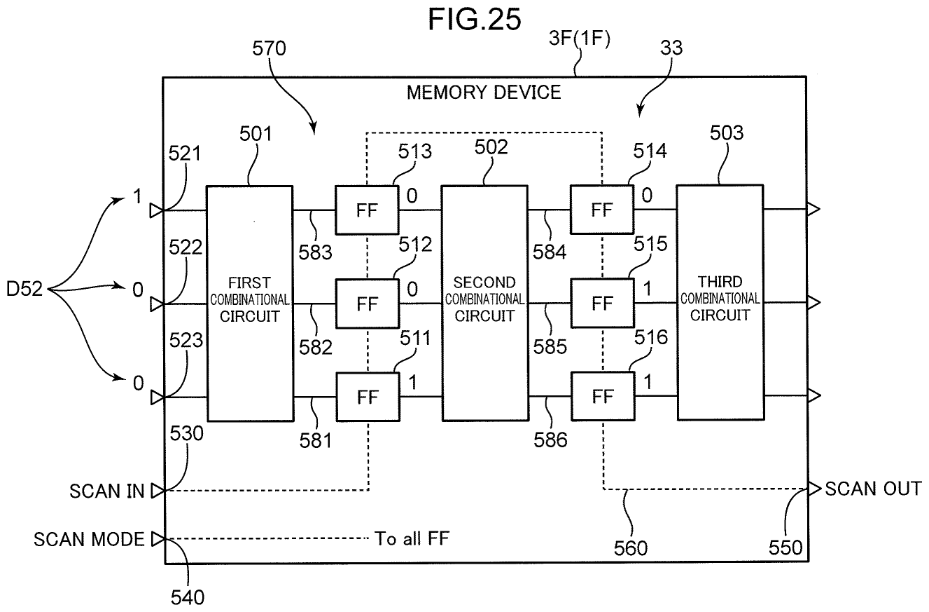

FIG. 25 is a diagram illustrating how each flip-flop circuit of the controller 33 is updated. Hereinafter, a case where the second plurality of data signals include a first data signal, a second data signal, and a third data signal is assumed. In the example illustrated in FIG. 25, the first data signal indicates “1”, and is input to the first combinational circuit 501 through the first input interface 521. The second data signal indicates “0”, and is input to the first combinational circuit 501 through the second input interface 522. The third data signal indicates “0”, and is input to the first combinational circuit 501 through the third input interface 523. The first flip-flop circuit 511 to the third flip-flop circuit 513 are updated by the first data signal to the third data signal output from the first combinational circuit 501. The fourth flip-flop circuit 514 to the sixth flip-flop circuit 516 are updated in accordance with respective logic values output through the second combinational circuit 502, on the basis of values set in the first flip-flop circuit 511 to the third flip-flop circuit 513 upon input of the first plurality of data signals.

Next, the host device transmits a signal including an instruction to turn on a scan mode to the memory device 3F. Based on this signal, the memory device 3F switches on the scan mode of the scan circuit 570 again. Then, the memory device 3F causes each flip-flop circuit to output its output signal through the scan-out terminal 550.

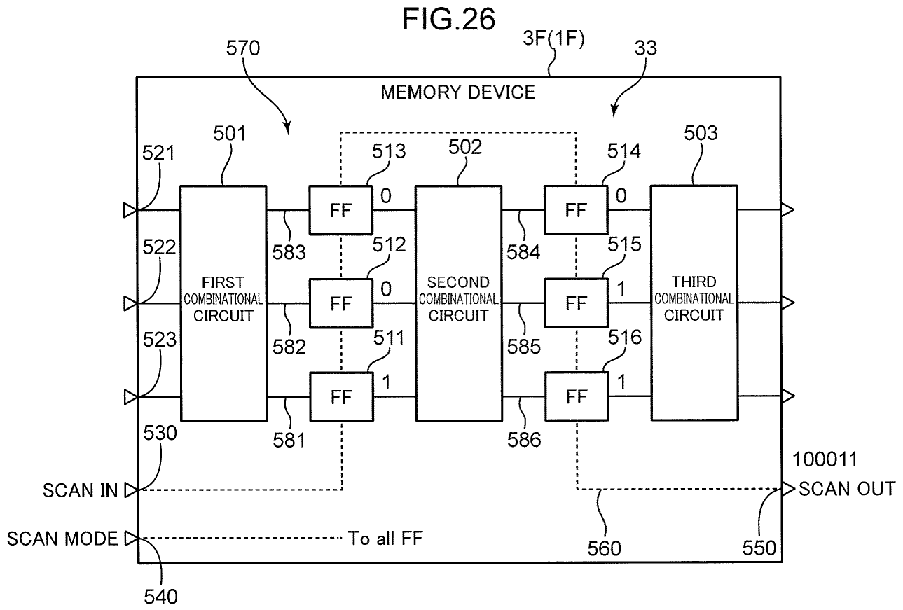

FIG. 26 is a diagram illustrating a state in which the values set in the respective flip-flop circuits, after being updated, are output through the scan-out terminal 550. In the example illustrated in FIG. 26, data signals are output from the scan-out terminal 550 in the order of 1, 1, 0, 0, 0, and 1. The memory device 3F transmits these data signals to the host device as the response data D2.

As described above, the host device according to the present modification example updates (hereinafter, referred to as first update) each flip-flop circuit with the first plurality of data signals, and updates (hereinafter, referred to as second update) the first flip-flop circuit 511 to the third flip-flop circuit 513 again with the second plurality of data signals. Here, the first plurality of data signals have different relative phase differences with respect to the clock signal CLK. Similarly, the second plurality of data signals have different relative phase differences with respect to the clock signal CLK. As described above, in a case where the memory device 3F is a counterfeit product, capability (specification) to determine a value indicated by a data signal is different from that of a genuine product. For this reason, in the first update or the second update, there is a high possibility that a flip-flop circuit in the controller 33 of a counterfeit product is updated in a mode different from a flip-flop circuit in the controller 33 of a genuine product. Moreover, in the second update, the first flip-flop circuit 511 to the third flip-flop circuit 513 are updated using the first combinational circuit 501, and the fourth flip-flop circuit 514 to the sixth flip-flop circuit 516 are updated using the second combinational circuit 502. For this reason, in a case where the memory device 3F is a counterfeit product and does not include a combinational circuit corresponding to the first combinational circuit 501 and the second combinational circuit 502 of a genuine product, there is a high possibility that the response data D2 different from that of the memory device 3F of a genuine product is output from the scan-out terminal 550.

Next, the host device stores the response data D2 sent from the memory device 3F in the measurement value storage buffer 26.

Next, the expected value comparator 28 of the host device determines whether or not the memory device 3F is a genuine product by comparing the expected value data D3 stored in the expected value storage memory 27 with the response data D2 stored in the measurement value storage buffer 26. In this example, in a case where data signals are output in the order of 1, 1, 0, 0, 0, and 1, the expected value comparator 28 determines that the memory device 3F is a genuine product.

Then, in a case of determining that the memory device 3F is a genuine product, the host device resumes the normal operation of the host device. On the other hand, in a case where the expected value comparator 28 determines that the memory device 3F is a counterfeit product, operation stop, re-authentication, or the like is performed.

As described above, in the present modification example, the response data D2 is generated using the scan circuit 570. The memory device 3F as a counterfeit product often does not include the scan circuit 570. In a case where a counterfeit product does not include the scan circuit 570, the response data D2 having content different from that of the memory device 3F as a genuine product is generated, and the expected value comparator 28 can easily identify whether a product is genuine or counterfeit.

Further, in this modification, the response data D2 is generated by using not only a flip-flop circuit disposed in an outer-side region within the memory device 3F (the flip-flop circuit 32 of the host I/F 31) but also flip-flop circuits disposed in an inner-side region within the memory device 3F (the first flip-flop circuit 511 through the sixth flip-flop circuit 516 of the controller 33), together with the combinational circuits 501, 502, and 503. For this reason, a malicious third party cannot duplicate the response data D2 of a genuine product without analyzing not only a flip-flop circuit on the outside but also a flip-flop circuit and a plurality of the combinational circuits 501, 502, and 503 on the inside. As a result, forgery difficulty of the memory device 3F is further improved.

### Modification Example 1-10

A host device of the information processing system according to the present modification example outputs the clock signal CLK at a high frequency (for example, 500 MHz) to a memory device, and performs authenticity determination based on response data from the memory device.

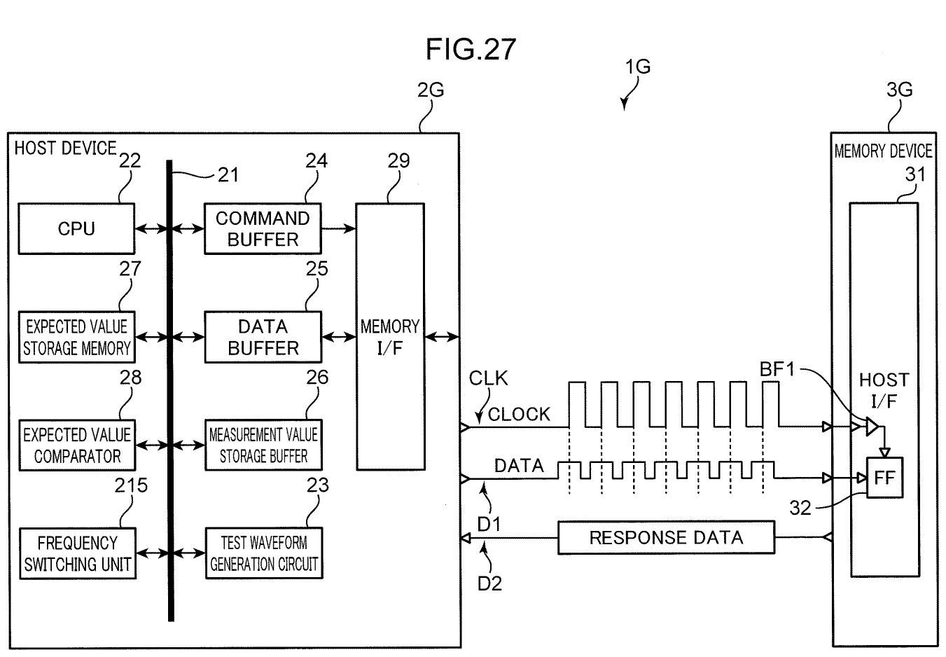

FIG. 27 is a diagram schematically illustrating data transmitted and received between a host device 2G and a memory device 3G of an information processing system 1G according to Modification Example 1-10. The host device 2G includes a first circuitry, and the memory device 3G includes a second circuitry. The first circuitry of the host device 2G includes a frequency switching unit 215. The frequency switching unit 215 inputs a frequency switching instruction including an instruction to switch a frequency of the clock signal CLK between a reference frequency (an example of a first frequency) and a high frequency (an example of a second frequency) at a frequency higher than the reference frequency to the test waveform generation circuit 23. The test waveform generation circuit 23 switches a frequency of the clock signal CLK between the reference frequency and the high frequency based on the frequency switching instruction. The reference frequency is, for example, 250 MHz, and the high frequency is, for example, 500 MHz.

In the example illustrated in FIG. 27, the clock signal CLK at a high frequency is received by a buffer BF1 included in the host I/F 31 of the memory device 3G. The buffer BF1 inputs the clock signal CLK to the flip-flop circuit 32. The flip-flop circuit 32 determines a value indicated by each of a plurality of data signals at a timing defined by the clock signal CLK at a high frequency received from the buffer BF1. Although detailed illustration is omitted, relative phase differences of a plurality of data signals with respect to the clock signal CLK may be different from each other. The flip-flop circuit 32 sends a plurality of data signals read by the flip-flop circuit 32 back to the host device 2G without modification.

A memory device as a counterfeit product is usually equipped with an FPGA that can operate when a frequency of the clock signal CLK is at 250 MHz during operation. In a case where the FPGA is mounted on a counterfeit product, in a case where the clock signal CLK at a high frequency (for example, 500 MHz) is transmitted as in the present modification example, it is assumed that the buffer BF1 cannot appropriately process the clock signal CLK, and as a result, the flip-flop circuit 32 of the counterfeit product reads a plurality of data signals in a mode different from that of a genuine product. Therefore, the host device 2G can accurately identify whether the memory device 3G is a genuine product or a counterfeit product by determining whether or not pass/fail information generated based on the response data D2 sent back from the memory device 3G matches genuine product pass/fail information stored in the expected value storage memory 27.

According to the present modification example, a frequency of the clock signal CLK can be switched between the reference frequency and the high frequency. For this reason, the expected value comparator 28 can determine whether or not the memory device 3G is a genuine product based on whether or not the memory device 3G can cope with the high frequency. Therefore, it is possible to more accurately identify whether or not the memory device 3G is a genuine product.

Further, in order to support the clock signal CLK at a high frequency as in the present modification example, a manufacturer of the memory device 3G as a counterfeit product is forced to mount a higher-performance (expensive) FPGA on the counterfeit product. This leads to increase in manufacturing cost of the counterfeit product, and thus, it is possible to improve forgery difficulty of the memory device 3G from the viewpoint of cost. Note that, since the memory device 3G of a genuine product is often manufactured with an ASIC, influence on cost is smaller than that with an FPGA.

The host device 2G according to the present modification example may further include the circuit setting unit 213 described in Modification Example 1-8. Further, the controller 33 of the memory device 3G may further include the first selector 431 to the third selector 433 described in Modification Example 1-8. Then, according to a circuit selection signal indicating a combinational circuit set by the circuit setting unit 213, the first selector 431 to the third selector 433 may operate to switch a critical path of a data signal. That is, it may be verified whether or not a flip-flop circuit provided in the inside of the memory device 3G (the controller 33) supports the high-frequency clock signal CLK. In this way, since a manufacturer of a memory device as a counterfeit product is forced to make a flip-flop circuit provided in the inside of the counterfeit product (the controller 33) capable of supporting high frequencies, forgery difficulty is further improved.

Further, the controller 33 of the memory device 3G according to the present modification example may be provided with the scan circuit 570 described in Modification Example 1-9. In this case, the host device 2G may transmit a plurality of data signals together with the clock signal CLK at a high frequency to a plurality of flip-flop circuits of the scan circuit 570, and the expected value comparator 28 may perform authenticity determination for the memory device 3G based on the response data D2 output from the scan-out terminal 550 of the scan circuit 570. That is, it may be verified whether or not a flip-flop circuit provided in the inside (the controller 33) of the memory device 3G supports the high-frequency clock signal CLK. In this way, since a manufacturer of the memory device 3G as a counterfeit product is forced to make a flip-flop circuit provided in the inside of the memory device 3G (the controller 33) capable of supporting high frequencies, forgery difficulty is further improved.

Further, the host device 2G may include a duty ratio changing unit that changes a duty ratio of the clock signal CLK instead of the frequency switching unit 215. The duty ratio changing unit may set a width of a High interval of the clock signal CLK at a reference frequency (for example, 250 MHz) to be equal to a width (for example, 1 ns) of a High interval of the clock signal CLK at a high frequency (for example, 500 MHz). That is, the duty ratio changing unit may adjust a duty ratio of the clock signal CLK to set a length of a High section of the clock signal CLK to a length equivalent to a length of a High section in a case where a frequency of the clock signal CLK is a high frequency while maintaining a frequency of the clock signal CLK at the reference frequency. Also in this configuration, it is possible to determine whether or not the memory device 3G can support the clock signal CLK at a high frequency.

In the present modification example, the example in which the buffer BF1 of the memory device 3G inputs the clock signal CLK at a high frequency to the flip-flop circuit 32 is described, but the buffer BF1 may return the clock signal CLK to the host device 2G. That is, the authenticity determination may be performed using a frequency characteristic of a logic element such as a buffer instead of performing the authenticity determination using a frequency characteristic of a flip-flop circuit.

### Modification Example 1-11

An information processing system 1H according to the present modification example performs the authenticity determination based on whether or not a memory device 3H can support a plurality of voltage levels.

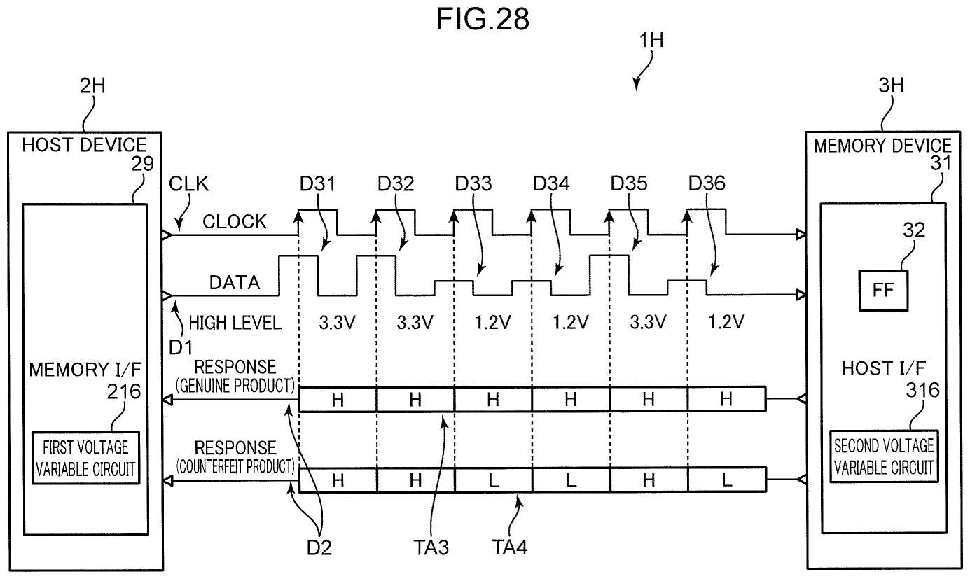

FIG. 28 is a diagram schematically illustrating data transmitted and received between a host device 2H and the memory device 3H according to the present modification example. The information processing system 1H includes the host device 2H and the memory device 3H. The host device 2H includes a first circuitry, and the memory device 3H includes a second circuitry. The first circuitry of the host device 2H includes a first voltage variable circuit 216. The first voltage variable circuit 216 switches a voltage level of the at least one of data signal D1 between low voltage (an example of first voltage) and high voltage (an example of second voltage) having a voltage level higher than the low voltage. The second circuitry of the memory device 3H includes a second voltage variable circuit 316 that switches a voltage level of the at least one of data signal D1 acquired by the flip-flop circuit 32 of the host I/F 31 between the low voltage and the high voltage. Specifically, a buffer circuit is arranged before the flip-flop circuit 32, and the second voltage variable circuit 316 switches a voltage level receivable by the buffer circuit.

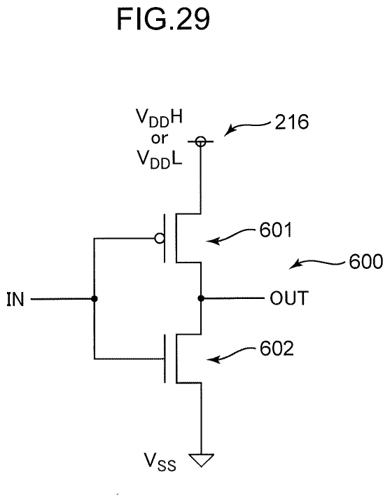

FIG. 29 is a diagram illustrating an example of a configuration of the first voltage variable circuit 216. The first voltage variable circuit 216 illustrated in FIG. 29 includes a CMOS transistor 600. The CMOS transistor 600 includes a pMOS transistor 601 arranged between the power supply voltage VDD and the output OUT, and an nMOS transistor 602 arranged between the ground VSS and the output OUT. In the example illustrated in FIG. 29, voltage supplied to the power supply voltage (supply voltage) VDD is configured to be switchable between VDDH and VDDL. VDDH corresponds to a high voltage (for example, 3.3 V) and VDDL corresponds to a low voltage (for example, 1.2 V). In a case where the host device 2H includes the first voltage variable circuit 216 illustrated in FIG. 29, the memory device 3H includes the second voltage variable circuit 316 having a similar configuration to the first voltage variable circuit 216.

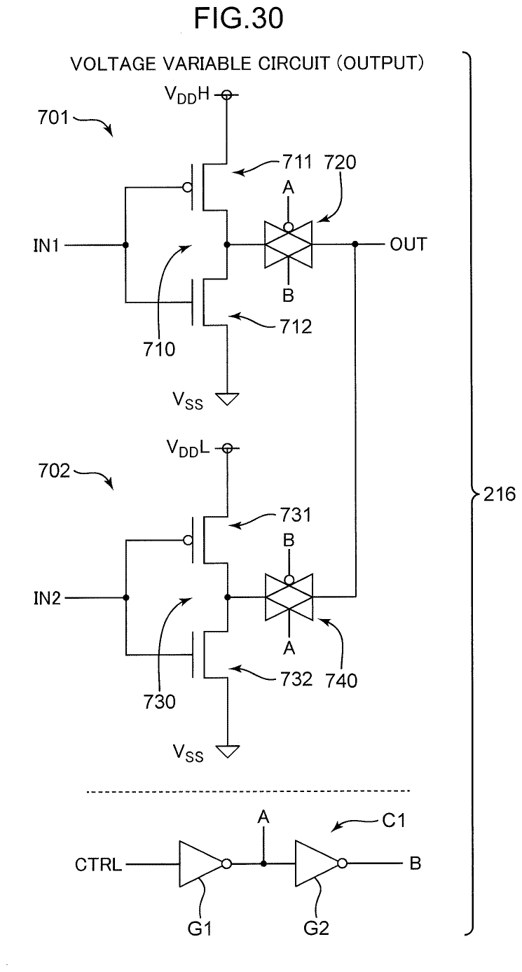

FIG. 30 is a diagram illustrating another example of the configuration of the first voltage variable circuit 216. The first voltage variable circuit 216 illustrated in FIG. 30 includes a first circuit 701, a second circuit 702, and a first control circuit C1.

The first circuit 701 includes a first CMOS transistor 710 and a first switch 720. The first CMOS transistor 710 includes a first pMOS transistor 711 arranged between the power supply voltage VDDH and the output OUT, and a first nMOS transistor 712 arranged between the ground VSS and the output OUT. A high voltage (for example, 3.3 V) is supplied from the power supply voltage VDDH. The first switch 720 includes a low active A terminal and a high active B terminal.

The second circuit 702 includes a second CMOS transistor 730 and a second switch 740. The second CMOS transistor 730 includes a second pMOS transistor 731 arranged between the power supply voltage VDDL and the output OUT, and a second nMOS transistor 732 arranged between the ground VSS and the output OUT. A low voltage (for example, 1.2 V) is supplied from the power supply voltage VDDL. The second switch 740 includes a high active A terminal and a low active B terminal.

The first control circuit C1 includes a first NOT gate G1 and a second NOT gate G2. The first NOT gate G1 includes an input terminal that receives a control signal CTRL. An output value of the first NOT gate G1 is input to the A terminal of the first switch 720, the A terminal of the second switch 740, and the second NOT gate G2. The second NOT gate G2 includes an input terminal that receives an output value of the first NOT gate G1. An output value of the second NOT gate G2 is input to the B terminal of the first switch 720 and the B terminal of the second switch 740.

In the first voltage variable circuit 216, in a case where a voltage level of the control signal CTRL is High and a voltage level of a first input signal IN1 is Low, the first switch 720 connects the power supply voltage VDDH and the output OUT. By this, a high voltage (for example, 3.3 V) is output from OUT. Further, in a case where a voltage level of the control signal CTRL is Low and a voltage level of a second input signal IN2 is Low, the second switch 740 connects the power supply voltage VDDL and the output OUT. By this, a low voltage (for example, 1.2 V) is output from OUT.

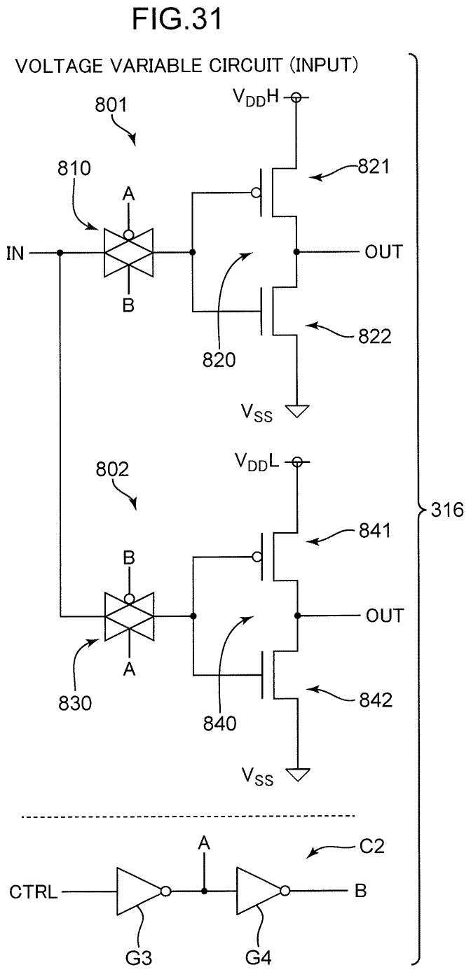

FIG. 31 is a diagram illustrating another example of the configuration of the second voltage variable circuit 316. The second voltage variable circuit 316 includes a third circuit 801, a fourth circuit 802, and a second control circuit C2.

The third circuit 801 includes a third switch 810 and a third CMOS transistor 820. The third switch 810 includes a low active A terminal and a high active B terminal. The third CMOS transistor 820 includes a third pMOS transistor 821 arranged between the power supply voltage VDDH and the output OUT, and a third nMOS transistor 822 arranged between the ground VSS and the output OUT. A high voltage (for example, 3.3 V) is supplied from the power supply voltage VDDH.

The fourth circuit 802 includes a fourth switch 830 and a fourth CMOS transistor 840. The fourth switch 830 includes a high active A terminal and a low active B terminal. The fourth CMOS transistor 840 includes a fourth pMOS transistor 841 arranged between the power supply voltage VDDL and the output OUT, and a fourth nMOS transistor 842 arranged between the ground VSS and the output OUT. A low voltage (for example, 1.2 V) is supplied from the power supply voltage VDDL.

The second control circuit C2 includes a third NOT gate G3 and a fourth NOT gate G4. The third NOT gate G3 includes an input terminal that receives the control signal CTRL. An output value of the third NOT gate G3 is input to the A terminal of the third switch 810, the A terminal of the fourth switch 830, and the fourth NOT gate G4. The fourth NOT gate G4 includes an input terminal that receives an output value of the third NOT gate G3. An output value of the fourth NOT gate G4 is input to the B terminal of the third switch 810 and the B terminal of the fourth switch 830. The control signal CTRL input to the second control circuit C2 is common to the control signal CTRL input to the first control circuit C1. That is, in a case where the control signal CTRL indicating High is input to the first control circuit C1, the control signal CTRL indicating High is input to the second control circuit C2.

In the second voltage variable circuit 316 having the above configuration, in a case where the control signal CTRL is High and the input signal IN is Low, the fourth switch 830 is turned off, while the gate terminals of the third switch 810 and the third pMOS transistor 821 are turned on. By this, the power supply voltage VDDH is output from OUT. In the present modification example, in a case where the power supply voltage VDDH is output from OUT, the lower limit threshold VIH in the memory device 3H is set to a first threshold. The first threshold is a threshold corresponding to a low voltage, and is, for example, 0.6 V.

Further, in the second voltage variable circuit 316, in a case where the control signal CTRL is Low and the input signal IN is Low, the third switch 810 is turned off, while gate terminals of the fourth switch 830 and the fourth pMOS transistor 841 are turned on. By this, the power supply voltage VDDL is output from OUT. In the present modification example, in a case where the power supply voltage VDDL is output from OUT, the lower limit threshold VIH in the memory device 3H is set to a second threshold. The second threshold is a threshold corresponding to a high voltage, and is, for example, 2 V.

As described above, in the memory device 3H according to the present modification example, the second voltage variable circuit 316 is controlled by the control signal CTRL and the input signal IN, so that the lower limit threshold VIH is switched between the first threshold and the second threshold. For this reason, the memory device 3H can recognize both a 3.3 V data signal and a 1.2 V data signal as High signals.

Processing of the information processing system 1H according to Modification Example 1 -11 will be described with reference to FIG. 28 again.

First, the host device 2H shares a change timing of a voltage level with the memory device 3H as a genuine product. As a sharing method, any one of the sharing methods (i), (ii), and (iii) described in Modification Example 1-3 may be used.

Next, the host device 2H transitions to the authentication phase at the time of startup or periodically.

Next, the test waveform generation circuit 23 of the host device 2H generates the at least one of data signal D1 and the clock signal CLK in order to verify whether or not the memory device 3H can support a plurality of voltage levels. For example, the test waveform generation circuit 23 generates the first data signals D31 to D36 (FIG. 28) as the at least one of data signal D1. Although detailed illustration is omitted, the relative phase differences of these data signals with respect to the clock signal CLK may be different from each other.

Next, the host device 2H transmits the clock signal CLK and the at least one of data signal D1 to the memory device 3H via the command buffer 24, the data buffer 25, and the memory I/F 29. At this time, the first voltage variable circuit 216 of the host device 2H changes a voltage level of any of a plurality of data signals at a change timing of a voltage level shared in advance with the memory device 3H. Further, the memory device 3H changes the lower limit threshold VIH by driving the second voltage variable circuit 316 at the change timing described above. In the example illustrated in FIG. 28, the host device 2H transmits the first data signal D31 and the second data signal D32 at a high voltage (for example, 3.3 V), transmits the third data signal D33 and the fourth data signal D34 at a low voltage (for example, 1.2 V), transmits the fifth data signal D35 at a high voltage, and transmits the sixth data signal D36 at a low voltage.

These data signals are received by the flip-flop circuit 32 of the host I/F 31 of the memory device 3H. Further, the flip-flop circuit 32 sends a plurality of data signals received from the host device 2H back to the host device 2H. Based on the response data D2 sent back from the memory device 3H, the host device 2H determines whether the memory device 3H recognizes each data signal as a High signal or a Low signal. A genuine product table TA3 of FIG. 28 is a table showing recognition results of a plurality of data signals by the memory device 3H as a genuine product. “H” in the genuine product table TA3 indicates that the flip-flop circuit 32 recognizes a data signal as a High signal, and “L” indicates that the flip-flop circuit 32 recognizes a data signal as a Low signal. As described above, the memory device 3H as a genuine product shares a timing of changing a voltage level of a data signal with the host device 2H. For this reason, the memory device 3H as a genuine product sets the lower limit threshold VIH to the first threshold (for example, 2 V) at a timing at which a data signal of 3.3 V is sent from the host device 2H, and sets the lower limit threshold VIH to the second threshold (for example, 0.6 V) at a timing at which a data signal of 1.2 V is sent. As a result, as shown in the genuine product table TA3, the flip-flop circuit 32 of the memory device 3H as a genuine product recognizes all of the first data signal D31 to the sixth data signal D36 as High signals.

A counterfeit product table TA4 of FIG. 28 is a table showing recognition results of a plurality of data signals by the memory device 3H as a counterfeit product. As shown in the counterfeit product table TA4, the flip-flop circuit 32 of the memory device 3H as a counterfeit product recognizes the third data signal D33, the fourth data signal D34, and the sixth data signal D36 sent from the host device 2H as Low signals. Since the memory device 3H as a counterfeit product often supports only a fixed High level, and therefore the memory device 3H often does not operate normally when a voltage level different from an assumed voltage level is input. For example, it is assumed that the memory device 3H as a counterfeit product is designed on the assumption that a data signal of 3.3 V is transmitted from the host device 2H. Specifically, it is assumed that the lower limit threshold VIH in the memory device 3H as a counterfeit product is fixed at 2 V. Here, when a data signal having a voltage of 1.2 V is transmitted from the host device 2H, the memory device 3H as a counterfeit product cannot recognize that this data signal is a High signal. Further, it is assumed that the memory device 3H as a counterfeit product is designed on the assumption that a data signal of 1.2 V is transmitted as a High signal from the host device 2H. Specifically, it is assumed that the lower limit threshold VIH of the memory device 3H as a counterfeit product is fixed at 0.6 V. Here, when a data signal of 3.3 V is transmitted from the host device 2H, withstand voltage of a CMOS transistor of the memory device 3H as a counterfeit product is exceeded, and the memory device 3H as a counterfeit product fails. As a result, the counterfeit product does not operate normally. As a result, the memory device 3H as a counterfeit product recognizes a data signal transmitted from the host device 2H in a mode different from that of a genuine product.

Next, the host device 2H stores the response data D2 sent from the memory device 3H in the measurement value storage buffer 26.

Next, the expected value comparator 28 of the host device 2H compares the expected value data D3 in the expected value storage memory 27 with the response data D2, and determines whether or not the expected value data D3 and the response data D2 match each other. That is, the expected value comparator 28 determines whether or not the memory device 3H can recognize a plurality of data signals in a mode similar to that of a memory device as a genuine product. In a case where the memory device 3H can recognize a plurality of data signals in a mode similar to that of a memory device as a genuine product, the expected value comparator 28 determines that the memory device 3H is a genuine product. In this case, the host device 2H resumes the normal operation. In a case where the memory device 3H cannot recognize a plurality of data signals in a mode similar to that of a memory device as a genuine product, the expected value comparator 28 determines that the memory device 3H is a counterfeit product. In this case, the host device 2H stops operation, performs re-authentication, or the like.

According to the present modification example, the expected value comparator 28 can determine whether or not the memory device 3H is a genuine product based on whether or not the memory device 3H can support a plurality of voltage levels. For this reason, it is possible to more accurately identify whether or not the memory device 3H is a genuine product.

### Modification Example 1-12

The authentication processing may be performed a plurality of times. In the authentication processing performed a plurality of times, in a case where data matches expected value data at a certain rate or more, the expected value comparator 28 may determine that the memory device 3 is a genuine product.

### Modification Example 1-13

In the first embodiment, the example in which the at least one of data signal D1 and the clock signal CLK for verifying setup time of the memory device 3 are transmitted to the memory device 3 in the authentication phase is described, but a timing at which these signals are transmitted may be variable. For example, the above signal may be transmitted during the normal operation (normal phase) of the host device 2. In this modification, it would be sufficient that the transmission timing be shared in advance.

According to the present modification example, since a timing at which the authentication processing is performed is unclear, forgery difficulty of the memory device 3 is further improved.

Further, the host device 2 and the memory device 3 may generate a common transmission timing based on a common rule. In this way, since a transmission timing does not flow on a communication path, difficulty in analyzing the transmission timing is improved. As a result, forgery difficulty of the memory device 3 is further improved.

### Modification Example 1-14

In the first embodiment, the example in which the expected value data D3 is stored in advance in the expected value storage memory 27 of the host device 2 is described, but a case in which the expected value data D3 is different for each individual or type of the memory device 3 and a case in which the expected value data D3 needs to be updated are also assumed. In view of the above, the expected value data D3 may be shared by any method of (a) to (d) below.
(a) The expected value data D3 is stored in the memory core 34 or the like of the memory device 3, and is transmitted to the host device 2 by encrypted communication. According to this method, it is possible to support a case where the expected value data D3 is different for each individual or each type.
(b) The host device 2 acquires the expected value data D3 stored in an external server via a communication network such as the Internet. According to this method, it is easy to update the expected value data D3.
(c) The host device 2 acquires expected value data D3 by performing one-to-one device-to-device communication with another device in a state where the host device 2 is not connected to a communication network such as the Internet (that is, in an off-line state). According to this method, since the expected value data D3 does not pass through a communication network such as the Internet, possibility of leakage of the expected value data D3 can be reduced.
(d) Each of the host device 2 and the memory device 3 generates the common expected value data D3 according to a common rule. According to this method, since the expected value data D3 is not transmitted and received between the host device 2 and the memory device 3, analysis difficulty of the expected value data D3 is improved.

### Modification Example 1-15

The memory core 34 is an example of a non-transitory recording medium. The memory core 34 may store an information processing program. The CPU 22 may execute digital processing by reading the information processing program. The digital processing includes processing of generating the clock signal CLK and the at least one of data signal D1, transmitting the clock signal CLK and the at least one of data signal D1 to the memory device 3, receiving the response data D2 generated by the memory device 3 based on the clock signal CLK and the at least one of data signal D1, and determining whether or not the memory device 3 is a genuine product based on the expected value data D3 stored in the expected value storage memory 27 included in the host device 2 and indicating that the memory device 3 is a genuine product and the response data D2. That is, operation of the host device 2 according to the first embodiment may be realized by the CPU 22 reading an information processing program and the CPU 22 operating according to the program.

Although not illustrated, the host device 2 may include a non-transitory recording medium such as a ROM. The information processing program described above may be stored in the recording medium.

### Modification Example 1-16

In the first embodiment and Modification Example 1 -1 to Modification Example 1-15, the example in which a host device (information processing device such as a computer) determines whether or not a memory device (memory card) is a genuine product is described, but the embodiment of the present disclosure is not limited to this. The present disclosure may be used by a memory device to determine whether or not a host device is a genuine product. Similarly, the present disclosure may be used by a toner cartridge to determine whether a main body of a multifunction peripheral or a printer is a genuine product. Further, the present disclosure may be used by a memory card to determine whether or not a main body of a game machine is a genuine product. That is, the “signal processing device” described in the claims may be a memory card such as a flash memory, a toner cartridge, a memory card storing a game program, or the like, and the “auxiliary device” may be an information processing device such as a computer, a main body of a printer or a multifunction peripheral, a main body of a game machine, or the like.

### Second Embodiment

Hereinafter, an information processing system 101 according to a second embodiment of the present disclosure will be described focusing on a difference from the first embodiment.

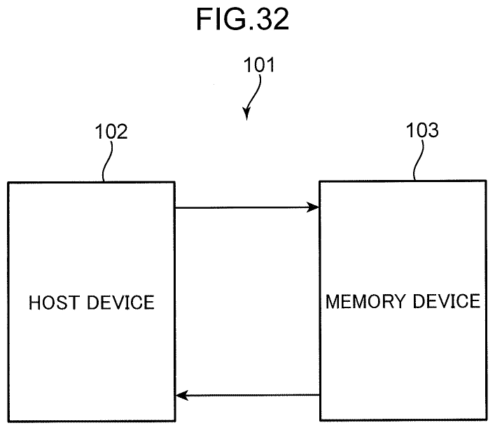

FIG. 32 is a diagram illustrating a configuration of the information processing system 101 according to the second embodiment in a simplified manner. As illustrated in FIG. 32, the information processing system 101 includes a host device 102 and the memory device 103.

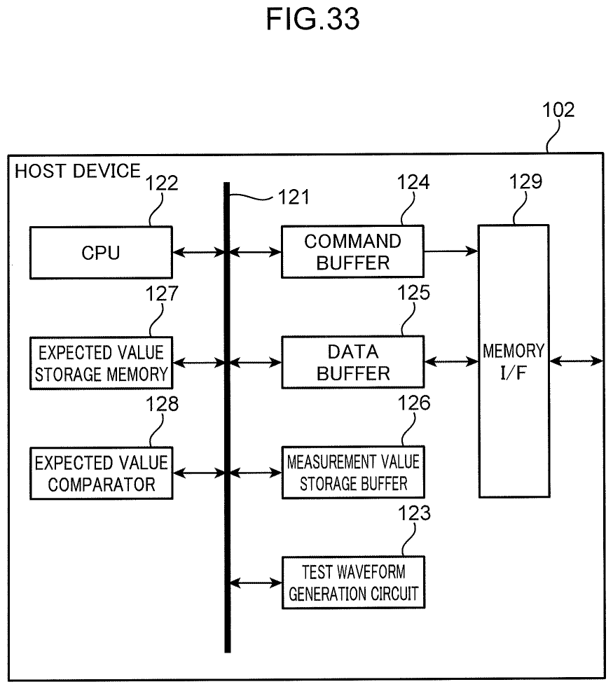

FIG. 33 is a diagram illustrating a configuration of the host device 102 in a simplified manner. In other words, FIG. 33 is a diagram illustrating a configuration of the first circuitry included in the host device 102 in a simplified manner. As illustrated in FIG. 33, the first circuitry of the host device 102 includes a plurality of processing blocks such as a CPU 122, a test waveform generation circuit 123, a command buffer 124, a data buffer 125, a measurement value storage buffer 126, an expected value storage memory 127, an expected value comparator 128, and a memory I/F 129, which are connected to each other via a bus 121.

The test waveform generation circuit 123 generates the clock signal CLK, a first instruction signal D101, and at least one data signal D102. The first instruction signal D101 includes an instruction to change drive capability of the memory device 103.

Configurations of the CPU 122, the command buffer 124, the data buffer 125, the memory I/F 129, the measurement value storage buffer 126, and the expected value comparator 128 of the host device 102 are similar to those described in the first embodiment, and will be omitted from detailed description.

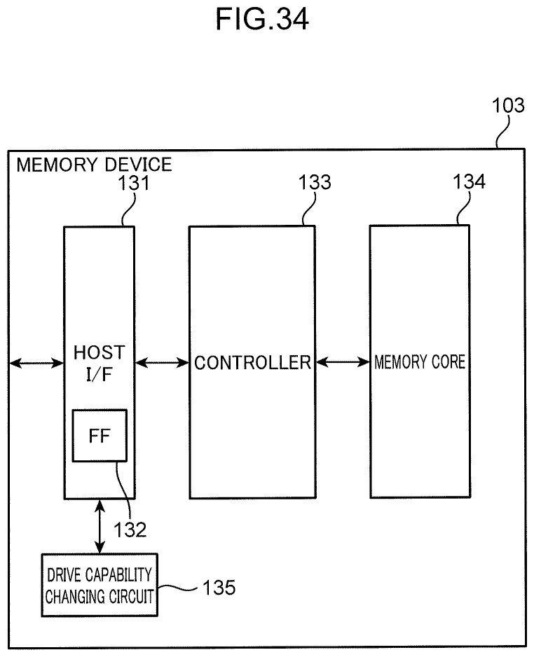

FIG. 34 is a diagram illustrating a configuration of the memory device 103 in a simplified manner. In other words, FIG. 34 is a diagram illustrating a configuration of the second circuitry included in the memory device 103 in a simplified manner. As illustrated in FIG. 34, the second circuitry of the memory device 103 includes a plurality of processing blocks such as a host I/F 131, a controller 133, a memory core 134, and a drive capability changing circuit 135.

The host I/F 131 includes a flip-flop circuit 132. The flip-flop circuit 132 receives the clock signal CLK, the first instruction signal D101, and the at least one of data signal D102 generated by the host device 102.

Configurations of the controller 133, the memory core 134, and the drive capability changing circuit 135 are similar to those described in the first embodiment, and will be omitted from detailed description.

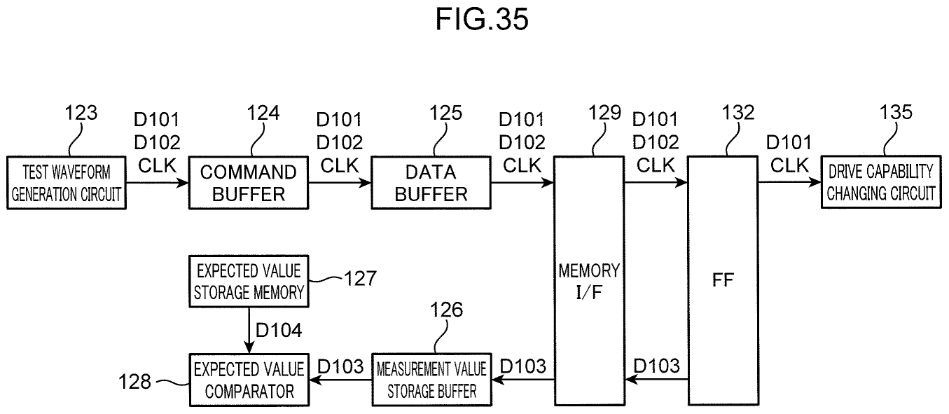

FIG. 35 is a diagram illustrating a flow of data in the information processing system 101 according to the second embodiment. As illustrated in FIG. 35, the test waveform generation circuit 123 generates the clock signal CLK, the first instruction signal D101, and the at least one of data signal D102. These pieces of data are transmitted to the host I/F 131 via the command buffer 124, the data buffer 125, and the memory I/F 129. The flip-flop circuit 132 of the host I/F 131 receives the clock signal CLK and the at least one of data signal D102. The drive capability changing circuit 135 receives the clock signal CLK and the first instruction signal D101. The flip-flop circuit 132 reads a plurality of data signals received by the host I/F 131, and sends the read data back to the memory I/F 129 of the host device 102. Response data D103 is stored in the measurement value storage buffer 126. The response data D103 stored in the measurement value storage buffer 126 and expected value data D104 stored in the expected value storage memory 127 are input to the expected value comparator 128.

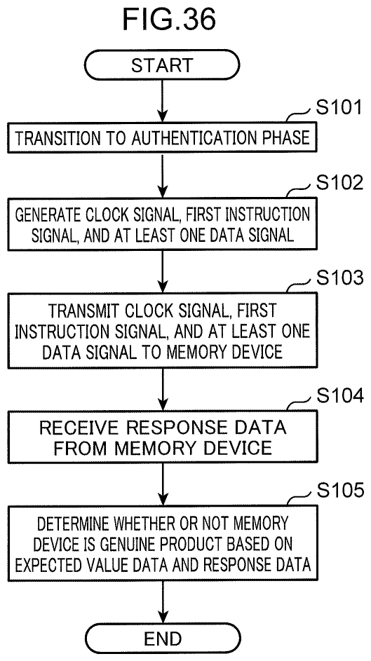

Operation of the host device 102 will be described with reference to FIG. 36. FIG. 36 is a flowchart illustrating a flow of authentication processing executed by the host device 102 according to the second embodiment.
In Step S101, the host device 102 transitions from the normal phase to the authentication phase.
In Step S102, the test waveform generation circuit 123 of the host device 102 generates the clock signal CLK, the first instruction signal D101, and the at least one of data signal D102.
In Step S103, the memory I/F 129 of the host device 102 transmits the clock signal CLK, the first instruction signal D101, and the at least one of data signal D102 to the memory device 103.
In Step S104, the memory I/F 129 of the host device 102 receives the response data D103 sent back from the memory device 103.
In Step S105, the expected value comparator 128 of the host device 102 determines whether or not the memory device 103 is a genuine product based on the response data D103 and the expected value data D104. In a case where the expected value comparator 128 determines that the memory device 103 is a genuine product, the host device 102 transitions from the authentication phase to the normal phase. That is, the host device 102 resumes the normal operation. On the other hand, in a case where the expected value comparator 128 determines that the memory device 103 is a counterfeit product, the host device 102 stops operation of the host device 102 and the memory device 103 or performs re-authentication.

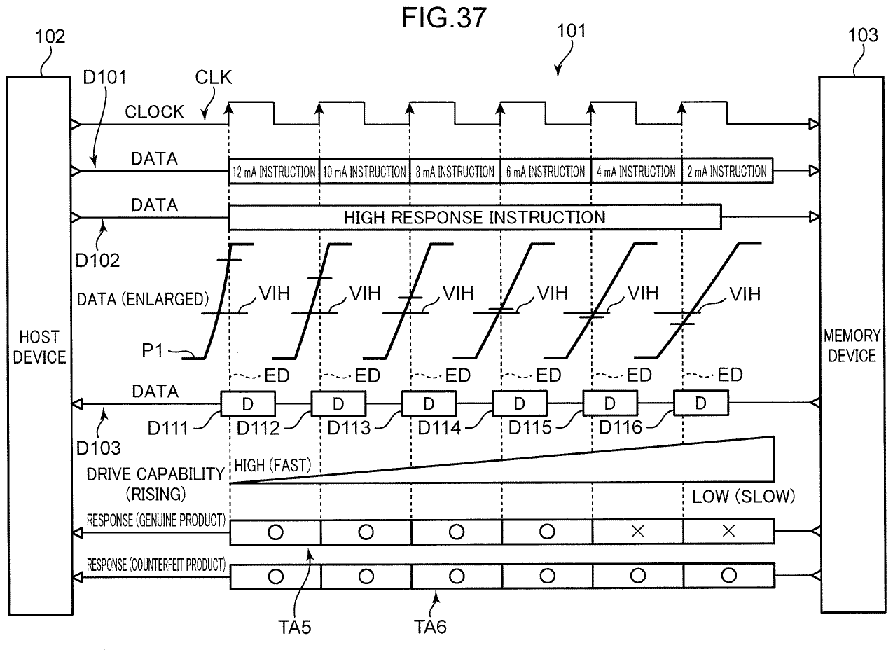

Next, overall operation of the information processing system 101 according to the second embodiment will be described. FIG. 37 is a diagram schematically illustrating data transmitted and received between the host device 102 and the memory device 103.

First, the host device 102 transitions to the authentication phase at the time of startup or periodically.

Next, the test waveform generation circuit 123 of the host device 102 generates the clock signal CLK, the first instruction signal D101, and the at least one of data signal D102. In the example illustrated in FIG. 37, the first instruction signal D101 includes a first instruction to change drive capability of the memory device 103 to 12 mA, a second instruction to change the drive capability to 10 mA, a third instruction to change the drive capability to 8 mA, a fourth instruction to change the drive capability to 6 mA, a fifth instruction to change the drive capability to 4 mA, and a sixth instruction to change the drive capability to 2 mA. Further, in the example illustrated in FIG. 37, the at least one of data signal D102 includes address information indicating an address at which a data signal in which a voltage level indicates High is stored in the memory core 134, and an instruction (High response instruction) requesting transmission of a data signal stored at an address indicated by the address information to the host device 102.

Next, the host device 102 transmits the clock signal CLK, the first instruction signal D101, and the High response instruction to the memory device 103 via the command buffer 124, the data buffer 125, and the memory I/F 129.

The clock signal CLK and the first instruction signal D101 are input to the drive capability changing circuit 135. The drive capability changing circuit 135 changes drive capability of the memory device 103 based on the first instruction signal D101. Further, the clock signal CLK and the High response instruction are received by the flip-flop circuit 132 of the host I/F 131. The flip-flop circuit 132 sends a data signal (High response) in which a voltage level indicates High back to the host device 2B based on address information and an instruction included in the High response instruction. That is, the flip-flop circuit 132 transmits a data signal in which a voltage level indicates High to the host device 2B as the response data D103. In the example illustrated in FIG. 37, the response data D103 includes first response data D111 to sixth response data D116. The first response data D111 to the sixth response data D116 are response data transmitted to the host device 102 in states where drive capability of the memory device 103 is set to 12 mA, 10 mA, 8 mA, 6 mA, 4 mA, and 2 mA, respectively.

The first pulse P1 illustrated in FIG. 37 indicates a state in which a signal of the first response data D111 rises from Low to High. Similarly, in the second pulse P2 to the sixth pulse P6, a signal of each of the second response data D112 to the sixth response data D116 rises from Low to High. Note that the first pulse P1 to the sixth pulse P6 indicate pulses of the first response data D111 to the sixth response data D116 transmitted from the memory device 103 as a genuine product to the host device 102. A broken line illustrated in FIG. 37 indicates the clock edge ED. The lower limit threshold VIH illustrated in FIG. 37 indicates a lower limit of a voltage level at which a data signal is determined to be a signal indicating High.

As illustrated in FIG. 37, a voltage level of the first pulse P1 at the clock edge ED exceeds the lower limit threshold VIH. Similarly, in the second pulse P2 to the fourth pulse P4, a voltage level of each pulse exceeds the lower limit threshold VIH at a time point of the clock edge ED. For this reason, the host device 102 recognizes that the first response data D111 to the fourth response data D114 are data signals (High responses) indicating High. On the other hand, in the fifth pulse P5 and the sixth pulse P6, a voltage level is lower than the lower limit threshold VIH at a time point of the clock edge ED. For this reason, the host device 102 recognizes that the fifth response data D115 and the sixth response data D116 are not High responses.

A genuine product table TA5 of FIG. 37 is a table indicating whether or not each piece of the response data D103 transmitted from the memory device 103 as a genuine product to the host device 102 is the High response. “○” in the genuine product table TA5 indicates that the memory device 103 as a genuine product succeeds in transmitting the High response to the host device 102. For this reason, “○” is assigned to fields corresponding to the first response data D111 to the fourth response data D114 in the genuine product table TA5. On the other hand, “×” indicates that the memory device 103 as a genuine product fails to transmit the High response to the host device 102. For this reason, “×” is assigned to fields corresponding to the fifth response data D115 to the sixth response data D116 in the genuine product table TA5.

A counterfeit product table TA6 of FIG. 37 is a table for explaining whether or not each piece of the response data D103 transmitted from the memory device 103 as a counterfeit product to the host device 102 is the High response. “○” indicates that the memory device 103 as a counterfeit product succeeds in transmitting the High response to the host device 102. As described above, in general, a circuit corresponding to the drive capability changing circuit 135 is not mounted on the memory device 103 as a counterfeit product. For this reason, the memory device 103 as a counterfeit product transmits the response data D103 to the host device 102 with constant drive capability (for example, 8 mA) regardless of a drive capability change instruction (the first instruction signal D101). For this reason, even in a case where the first instruction signal D101 is transmitted from the host device 102 to the memory device 103 such that a genuine product would not transmit the High response, a counterfeit product transmits the High response to the host device 102. For example, even in a case where the first instruction signal D101 to set drive capability to 4 mA or 2 mA is sent to the memory device 103, the memory device 103 as a counterfeit product succeeds in transmitting the High response to the host device 102 as shown in fields corresponding to the fifth response data D115 and the sixth response data D116 in the counterfeit product table TA6. Alternatively, even in a case where the first instruction signal D101 that allows the memory device 103 as a genuine product to transmit the High response is transmitted to the memory device 103, the memory device 103 as a counterfeit product may transmit the Low response to the host device 102. As described above, by changing drive capability of the memory device 103, voltage levels of the response data D103 can be made different between a genuine product and a counterfeit product.

Next, the expected value comparator 128 of the host device 102 compares the expected value data D104 in the expected value storage memory 127 with the response data D103 to determine whether or not the memory device 103 can transmit the response data D103 having a voltage level similar to a voltage level of the response data D103 that a genuine product sends back to the host device 102. In a case where the expected value comparator 128 determines that the memory device 103 sends back the response data D103 having a voltage level similar to that of a genuine product, the host device 102 resumes the normal operation. On the other hand, in a case where the memory device 103 cannot send back the response data D103 having a voltage level similar to that of a genuine product, the host device 102 stops operation or performs re-authentication.

According to the information processing system 101 described above, the memory device 103 transmits the response data D103 in a state where drive capability is changed based on the first instruction signal D101. In a case where the memory device 103 is a counterfeit product, the first capability changing circuit is not provided, and the response data D103 is transmitted in a state where drive capability is fixed, so that content of the response data D103 is different from that of a genuine product. As a result, the expected value comparator 128 of the host device 102 can accurately identify whether the memory device 103 is a genuine product or a counterfeit product.

Hereinafter, various modification examples of the second embodiment will be described.

### Modification Example 2-1

The first circuitry of the host device 102 may include the constant current source 210 (FIG. 15) that changes a logical value of the response data D2 by drawing constant current from the memory device 103 or sending constant current to the memory device 103. Further, the host device 102 may include the current setting unit 220 (FIG. 15) that sets a current value of sink current generated by the constant current source 210 pulling current from the memory device 103 or source current generated by the constant current source 210 pushing current into the memory device 103.

Similarly to Modification Examples 1-6, the host device 102 according to this modification determines whether the memory device 103 is genuine, based on the characteristic that, when the sink current is set higher than the drive capability of the memory device 103 and the host device 102 transmits the High response instruction to the memory device 103, the response data is received by the host device 102 as the Low response. That is, in a state where the current setting unit 220 sets a current value of sink current to a predetermined value (for example, 12 mA), the host device 102 transmits a first instruction signal for instructing to set drive capability of the memory device 103 to a predetermined value (for example, 12 mA) and the High response instruction to the memory device 103. Then, the host device 102 determines that the memory device 103 is a genuine product or a counterfeit product based on whether or not the memory device 103 can send the High response back to the host device 102.

### Modification Example 2-2

The first circuitry of the host device 102 according to the present modification example may further include the temperature sensor 211 (FIG. 20) that measures an ambient temperature of the host device 102. Further, the expected value storage memory 127 of the host device 102 according to the present modification example may store a correspondence relationship between an ambient temperature of the host device 102 and a plurality of pieces of the expected value data D104. Further, the host device 102 may further include the selection unit 212 (FIG. 20) that selects the expected value data D104 corresponding to an ambient temperature measured by the temperature sensor 211 as specific data. The expected value comparator 128 according to the present modification example refers to specific data selected by the selection unit 212 to determine whether or not the memory device 103 is a genuine product, similarly to the expected value comparator 28 according to Modification Example 1-7 described above.

### Modification Example 2-3

The first circuitry of the host device 102 according to the present modification example may further include the frequency switching unit 215 (FIG. 27) that switches a frequency of the clock signal CLK between a reference frequency and a high frequency having a frequency higher than the reference frequency. The reference frequency is, for example, 250 MHz, and the high frequency is, for example, 500 MHz. Similarly to the host device 2G according to Modification Example 1-10 described above, the host device 102 according to the present modification example outputs the clock signal CLK at a high frequency (for example, 500 MHz) to the memory device 103, and performs authenticity determination based on whether or not the memory device 103 supports the clock signal CLK at a high frequency.

### Modification Example 2-4

The information processing system 101A according to the present modification example performs authenticity determination by determining whether or not the memory device 103A can support a plurality of voltage levels.

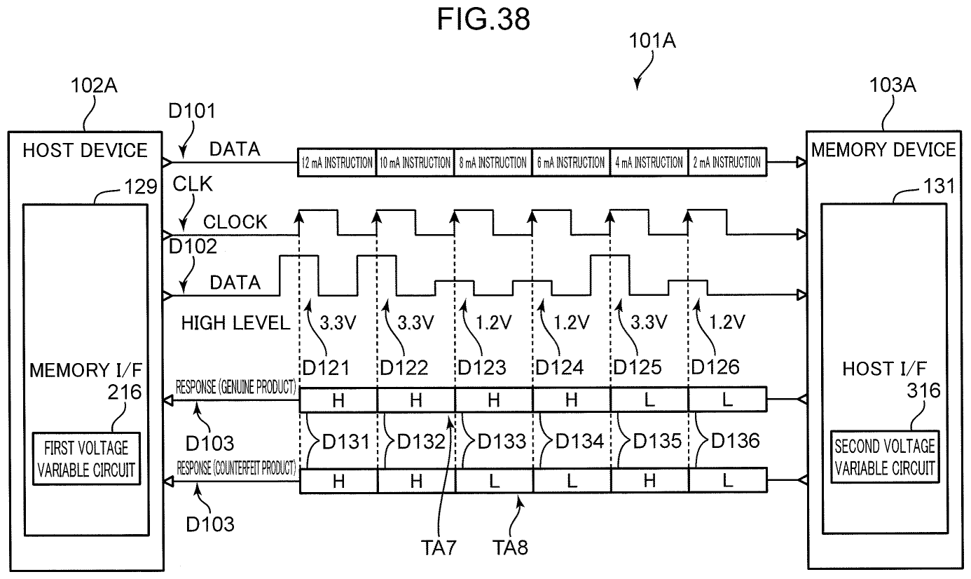

FIG. 38 is a diagram schematically illustrating an overall configuration of the information processing system 101A according to Modification Example 2-4 and data transmitted and received between a host device 102A and the memory device 103A. The information processing system 101A illustrated in FIG. 38 includes the host device 102A and the memory device 103A. The host device 102A includes a first circuitry, and the memory device 103A includes a second circuitry. The first circuitry of the host device 102A includes the first voltage variable circuit 216 that switches a voltage level of the at least one of data signal D102 between a low voltage and a high voltage having a voltage level higher than the low voltage. A configuration of the first voltage variable circuit 216 is similar to the configuration of the first voltage variable circuit 216 (FIG. 28) described in Modification Example 1-11, and will be omitted from description. The second circuitry of the memory device 103A includes the second voltage variable circuit 316 that switches a voltage level of the at least one of data signal D102 received by the host I/F 131 between a low voltage and a high voltage. Specifically, a buffer circuit is arranged before the flip-flop circuit 32, and the second voltage variable circuit 316 switches a voltage level receivable by the buffer circuit. A configuration of the second voltage variable circuit 316 is similar to the configuration of the second voltage variable circuit 316 (FIG. 28) described in Modification Example 1-11, and will be omitted from description.

Operation of the information processing system 101A according to Modification Example 2-4 will be described with reference to FIG. 38.

First, the host device 102A shares a change timing of a voltage level with the memory device 103A as a genuine product. As a sharing method, any of the sharing methods (i) to (iii) described in Modification Example 1-3 may be used.

Next, the host device 102A transitions to the authentication phase at the time of startup or periodically.

Next, the test waveform generation circuit 123 of the host device 102A generates the clock signal CLK, the first instruction signal D101, and the at least one of data signal D102.

Next, the host device 102A transmits the clock signal CLK, the first instruction signal D101, and the at least one of data signal D102 to the memory device 103A via the command buffer 124, the data buffer 125, and the memory I/F 129. Further, at this time, the first voltage variable circuit 216 of the host device 102A changes a voltage level of the at least one of data signal D102 according to a change timing of a voltage level shared in advance with the memory device 103A. The second voltage variable circuit 316 of the memory device 103A changes the lower limit threshold VIH at the time of receiving the at least one of data signal D102 according to the change timing. Furthermore, the drive capability changing circuit 135 of the memory device 103A changes drive capability of the memory device 103 based on the first instruction signal D101. In the example illustrated in FIG. 38, the host device 102A transmits a first data signal D121 to a sixth data signal D126 as the at least one of data signal D102. Here, the host device 102A transmits the first data signal D121 and the second data signal D122 at a high voltage (for example, 3.3 V), transmits the third data signal D123 and the fourth data signal D124 at a low voltage (for example, 1.2 V), transmits the fifth data signal D125 at a high voltage, and transmits the sixth data signal D126 at a low voltage.

These data signals are received by the flip-flop circuit 132 of the host I/F 131 of the memory device 103A. Further, the flip-flop circuit 132 sends a plurality of data signals received from the host device 102A back to the host device 102A as the response data D103. In the example illustrated in FIG. 38, the response data D103 includes first response data D131 to sixth response data D136. The first response data D131 to D136 are response data transmitted in states where drive capability of the memory device 103A is set to 12 mA, 10 mA, 8 mA, 6 mA, 4 mA, and 2 mA, respectively.

A genuine product table TA7 of FIG. 38 shows content of the response data D103 transmitted by the flip-flop circuit 132 of the memory device 103A as a genuine product. “H” in the genuine product table TA7 indicates that the flip-flop circuit 132 of the memory device 103A recognizes a data signal as a High signal and succeeds in transmitting the High response to the host device 102A. “L” indicates that the flip-flop circuit 132 recognizes a data signal as a Low signal or fails to transmit the High response to the host device 102A. As described above, the memory device 103A as a genuine product shares a timing of changing a voltage level of a data signal with the host device 102A. For this reason, the memory device 103A as a genuine product sets the lower limit threshold VIH to the first threshold (for example, 2 V) at a timing at which a data signal of 3.3 V is transmitted, and sets the lower limit threshold VIH to the second threshold (for example, 0.6 V) at a timing at which a data signal of 1.2 V is transmitted. For this reason, the flip-flop circuit 132 of the memory device 103A of a genuine product recognizes all of the first data signal D121 to the fourth data signal D124 as High signals. Here, as described above, the memory device 103A of a genuine product changes drive capability according to the first instruction signal D101. For this reason, as shown in the genuine product table TA7, transmission of the High response to the host device 102A fails with respect to the fifth response data D135 and the sixth response data D136.

A counterfeit product table TA8 of FIG. 38 shows content of the response data D103 transmitted by the flip-flop circuit 132 of the memory device 103A as a counterfeit product. As shown in the counterfeit product table TA8, the flip-flop circuit 132 of the memory device 103A as a counterfeit product recognizes the third data signal D123, the fourth data signal D124, and the sixth data signal D126 as Low signals. As described above, since the memory device 103A as a counterfeit product often supports only a fixed High level, the memory device 103A often does not operate normally when a voltage level different from an assumed voltage level is input. Further, drive capability of the memory device 103A as a counterfeit product is often fixed (for example, fixed at 8 mA). For this reason, even when the host device 102A sends the first instruction signal D101 such that the memory device 103A as a genuine product cannot transmit the High response, the memory device 103A as a counterfeit product may transmit the High response to the host device 102A. As described above, by switching a voltage level of the at least one of data signal D102 between the low voltage and the high voltage and changing drive capability of the memory device 103A, it is possible to more reliably make content of the response data D103 different between a genuine product and a counterfeit product.

Next, the host device 102A stores the response data D103 transmitted from the memory device 103A in the measurement value storage buffer 126.

Next, the expected value comparator 128 of the host device 102A compares the expected value data D104 in the expected value storage memory 127 with the response data D103, and determines whether or not the expected value data D104 and the response data D103 match each other. In a case where the data match each other, expected value comparator 128 determines that memory device 103A is a genuine product.

According to the present modification example, the expected value comparator 128 can determine whether or not the memory device 103A is a genuine product based on whether or not the memory device 103A can support a plurality of voltage levels. Therefore, the host device 102A can more accurately identify whether or not the memory device 103A is a genuine product.

Here, the example in which a voltage level of the at least one of data signal D102 is switched between the low voltage and the high voltage and drive capability of the memory device 103A is changed is described, but the drive capability of the memory device 103A does not need to be changed. That is, the host device 102A may determine whether or not the memory device 103A is a genuine product based on whether or not the memory device 103A can support a plurality of voltage levels. In this case, the first instruction signal D101 for changing drive capability of the memory device 103A does not need to be sent to the memory device 103A.

### Modification Example 2-5

The memory core 134 is an example of a non-transitory recording medium. The memory core 134 may store an information processing program. The CPU 122 may execute digital processing by reading the information processing program. The digital processing includes processing of generating the clock signal CLK, the first instruction signal D101 including an instruction to change drive capability of the memory device 103, and the at least one of data signal D102, transmitting the clock signal CLK, the first instruction signal D101, and the at least one of data signal D102 to the memory device 103, receiving the response data D103 generated by the memory device 103 based on the clock signal CLK, the first instruction signal D101, and the at least one of data signal D102, and determining whether or not the memory device 103 is a genuine product based on the response data D103 and the expected value data D104 stored in the expected value storage memory 127 included in the host device 102 and indicating that the memory device 103 is a genuine product. That is, operation of the host device 102 according to the second embodiment may be realized by the CPU 122 reading a program and the CPU 122 operating according to the program.

Although not illustrated, the host device 102 may include a non-transitory recording medium such as a ROM. The information processing program described above may be stored in the recording medium.

### Modification Example 2-6

Expected value data of a non-genuine product as a target may be stored in the expected value storage memory 127 of the host device 102. Then, in a case where the expected value data matches response data transmitted from the memory device 103, the expected value comparator 128 may determine that the memory device 103 is a non-genuine product.

### Modification Example 2-7

In the second embodiment and Modification Example 2-1 to Modification Example 2-6, the example in which a host device (information processing device such as a computer) determines whether or not a memory device (memory card) is a genuine product is described, but the embodiment of the present disclosure is not limited to this. The present disclosure may be used by a memory device to determine whether or not a host device is a genuine product. Similarly, the present disclosure may be used by a toner cartridge to determine whether a main body of a multifunction peripheral or a printer is a genuine product. Further, the present disclosure may be used by a memory card to determine whether or not a main body of a game machine is a genuine product. That is, the “signal processing device” described in the claims may be a memory card such as a flash memory, a toner cartridge, a memory card storing a game program, or the like, and the “auxiliary device” may be an information processing device such as a computer, a main body of a printer or a multifunction peripheral, a main body of a game machine, or the like.

### Summary of Embodiments

An information processing system according to a first aspect of the present invention includes a signal processing device including a first circuitry, and an auxiliary device connected to the signal processing device and including a second circuitry, in which the first circuitry generates a clock signal and a plurality of data signals having different relative phase differences with respect to the clock signal, and transmits the clock signal and the plurality of data signals to the second circuitry, the second circuitry receives the clock signal and the plurality of data signals, generates response data based on the clock signal and the plurality of data signals, and transmits the response data to the first circuitry, and the first circuitry receives the response data, includes a storage circuit that stores expected value data, and determines that the auxiliary device is a genuine product or the auxiliary device is a non-genuine product based on the expected value data and the response data.

There is a high possibility that time (setup time) in which data needs to be determined before a clock edge is different between a signal processing device as a genuine product and an auxiliary device as a counterfeit product. For this reason, a data signal output at a timing at which a genuine product can determine content of data cannot be determined by a counterfeit product in some cases. Alternatively, a data signal output at a timing at which a genuine product cannot determine content of data is determined by a counterfeit product in some cases.

Here, according to the above aspect, the first circuitry of the signal processing device transmits a plurality of data signals having different relative phase differences with respect to the clock signal. That is, the first circuitry shifts a timing of outputting a data signal for each of the data signals. Then, the first circuitry compares response data generated based on a plurality of the data signals with expected value data. By this, it is possible to check whether or not the second circuitry of the auxiliary device can determine a data signal output at a timing at which content of data can be normally determined by the genuine product. Further, it is possible to check whether or not the second circuitry can determine a data signal output at a timing at which content of data cannot be determined by the genuine product. That is, it is possible to accurately identify whether or not the auxiliary device is a genuine product.

In the information processing system according to a second aspect of the present invention, in the first aspect, the second circuitry includes a plurality of transmission paths, the clock signal or the plurality of data signals are received by the second circuitry via any one of a plurality of the transmission paths, and a delay amount of the clock signal or the plurality of data signals in each of a plurality of the transmission paths is different for each of a plurality of the transmission paths.

According to this aspect, a delay amount of the clock signal or a plurality of data signals varies depending on which transmission path among a plurality of transmission paths is used. By this, variations are generated in response data generated by the second circuitry of the auxiliary device. As a result, it is difficult to forge the response data, and thus forgery difficulty of the auxiliary device is improved.

In the information processing system according to a third aspect of the present invention, in the first aspect, the plurality of data signals include a first instruction signal including an instruction to change drive capability of the auxiliary device and a second instruction signal including an instruction to request transmission of a data signal at a predetermined voltage level, the second circuitry includes a first capability changing circuit that changes drive capability of the auxiliary device based on the first instruction signal, and the second circuitry generates the response data based on the clock signal and the second instruction signal.

According to this aspect, the second circuitry of the auxiliary device generates response data in a state where drive capability is changed based on the first instruction signal. In a case where the auxiliary device is a counterfeit product, the counterfeit product does not include the first capability changing circuit, and response data is generated in a state where drive capability is fixed, so that content of the response data is different from that of a genuine product. As a result, the first circuitry of the signal processing device can more accurately identify whether the auxiliary device is a genuine product or a counterfeit product.

In the information processing system according to a fourth aspect of the present invention, in the third aspect, the first circuitry includes a constant current source that generates sink current flowing from the auxiliary device to the signal processing device or source current flowing from the signal processing device to the auxiliary device, and sets a current value of the sink current or the source current.

According to this aspect, current values of the sink current and the source current are variable. For this reason, when a current value of the sink current or the source current and drive capability of the auxiliary device are set to a predetermined combination, it is possible to identify whether or not the auxiliary device is a genuine product based on whether or not the second circuitry of the auxiliary device generates appropriate response data.

In the information processing system according to a fifth aspect of the present invention, in the first aspect, the storage circuit stores a plurality of pieces of expected value data, the first circuitry selects any one piece of expected value data among a plurality of pieces of the expected value data as specific data, and the first circuitry determines that the auxiliary device is a genuine product or that the auxiliary device is a non-genuine product based on the specific data and the response data.

According to this aspect, the first circuitry of the signal processing device uses any one of a plurality of pieces of expected value data to determine that the auxiliary device is a genuine product or that the auxiliary device is a non-genuine product. In this way, a malicious third party needs to analyze all of a plurality of pieces of the expected value data in order to counterfeit the auxiliary device, and forgery difficulty of the auxiliary device is improved.

In the information processing system according to a sixth aspect of the present invention, in the fifth aspect, the storage circuit stores a correspondence relationship between a temperature and the plurality of pieces of expected value data, the first circuitry includes a temperature measurement unit, and the first circuitry selects, as the specific data, expected value data corresponding to a temperature measured by the temperature measurement unit.

According to this aspect, expected value data referred to by the first circuitry of the signal processing device is switched according to a temperature measured by the temperature measurement unit, so that forgery difficulty of the auxiliary device is further improved.

In the information processing system according to a seventh aspect of the present invention, in the fifth aspect, the first circuitry sets a circuit that allows the plurality of data signals to pass, the storage circuit stores a correspondence relationship between the circuit set by the first circuitry and a plurality of pieces of the expected value data, and the first circuitry selects, as the specific data, expected value data corresponding to the set circuit.

According to this aspect, expected value data referred to by the first circuitry is switched according to a circuit set by the first circuitry of the signal processing device, so that forgery difficulty of the auxiliary device is further improved.

In the information processing system according to an eighth aspect of the present invention, in the first aspect, the second circuitry includes a plurality of combinational circuits and a flip-flop circuit arranged in each of a plurality of connection paths connecting a plurality of the combinational circuits, the second circuitry includes a scan circuit formed by serially connecting each of the flip-flop circuits, and the plurality of data signals received by the second circuitry are input to at least one of an input unit of the scan circuit and any one of a plurality of the combinational circuits.

According to this aspect, response data is generated using at least one of the scan circuit and a plurality of the combinational circuits. In this way, since a malicious third party needs to analyze the scan circuit or a plurality of the combinational circuits in order to analyze response data of the auxiliary device as a genuine product, forgery difficulty of the auxiliary device is improved.

In the information processing system according to a ninth aspect of the present invention, in the first aspect, the first circuitry switches a frequency of the clock signal between a first frequency and a second frequency having a frequency higher than the first frequency.

According to this aspect, a frequency of the clock signal can be switched between the first frequency and the second frequency having a frequency higher than the first frequency. For this reason, the first circuitry of the signal processing device can determine that the auxiliary device is a genuine product or that the auxiliary device is a non-genuine product based on whether or not the auxiliary device supports both the first frequency and the second frequency. Therefore, it is possible to more accurately identify whether or not the auxiliary device is a genuine product.

In the information processing system according to a tenth aspect of the present invention, in the first aspect, the first circuitry includes a first voltage variable circuit that switches a voltage level of the plurality of data signals between a first voltage and a second voltage at a higher voltage level than the first voltage, and the second circuitry includes a second voltage variable circuit that switches a receivable voltage level between the first voltage and the second voltage.

According to this aspect, the first circuitry of the signal processing device can determine that the auxiliary device is a genuine product or that the auxiliary device is a non-genuine product based on whether or not the auxiliary device supports the first voltage and the second voltage. Therefore, it is possible to more accurately identify whether or not the auxiliary device is a genuine product.

An information processing system according to an eleventh aspect of the present invention includes a signal processing device including a first circuitry, and an auxiliary device connected to the signal processing device and including a second circuitry, in which the first circuitry generates a clock signal and one data signal, and transmits the clock signal and the one data signal to the second circuitry, the second circuitry includes a plurality of transmission paths, receives the clock signal and the one data signal that pass through at least two transmission paths among a plurality of the transmission paths, generates response data based on the clock signal and the one data signal, and transmits the response data to the first circuitry, a delay amount of the clock signal or the one data signal in each of a plurality of the transmission paths is different for each of a plurality of the transmission paths, and the first circuitry receives the response data, includes a storage circuit that stores expected value data, and determines that the auxiliary device is a genuine product or the auxiliary device is a non-genuine product based on the expected value data and the response data.

According to this aspect, a plurality of (at least two) pieces of response data can be generated based on the clock signal or one data signal. That is, the second circuitry of the auxiliary device can generate response data based on a clock signal or one data signal passing through one of a plurality of transmission paths and response data based on a clock signal or one data signal passing through another one of a plurality of the transmission paths. As described above, in a case where the second circuitry generates response data based on a clock signal or one data signal sent from the first circuitry of the signal processing device, an amount of data sent from the signal processing device to the auxiliary device can be reduced as compared with a case where the second circuitry generates response data based on a clock signal or a plurality of data signals sent from the first circuitry.

An auxiliary device according to a twelfth aspect of the present invention is an auxiliary device included in the information processing system according to the first aspect.

According to this aspect, it is possible to provide an auxiliary device used in the information processing system.

An auxiliary device according to a thirteenth aspect of the present invention is an auxiliary device including a second circuitry, in which the second circuitry receives a clock signal and a plurality of data signals, the second circuitry includes a plurality of transmission paths, a delay element provided in each of a plurality of the transmission paths, a flip-flop circuit, and a selector to which the clock signal and the plurality of data signals are input, the number of the delay elements is different for each of a plurality of the transmission paths, and the clock signal or the plurality of data signals that pass through the delay element are input to the selector.

According to this aspect, the second circuitry of the auxiliary device includes a plurality of transmission paths, and the number of delay elements provided in each of a plurality of the transmission paths is different for each of the transmission paths. For this reason, a delay amount until a clock signal or a plurality of data signals are input to the selector can be made different depending on which transmission path among a plurality of the transmission paths is used.

A signal processing device according to the fourteenth aspect of the present invention is a signal processing device including a first circuitry according to the first aspect, in which an auxiliary device including a second circuitry is connected to the signal processing device, the first circuitry generates a clock signal and a plurality of data signals having different relative phase differences with respect to the clock signal, transmits the clock signal and the plurality of data signals to the second circuitry, receives response data that the second circuitry generates based on the clock signal and the plurality of data signals, includes a storage circuit that stores expected value data, and determines that the auxiliary device is a genuine product or the auxiliary device is a non-genuine product based on the expected value data and the response data.

According to this aspect, an effect similar to that of the information processing system described above can be obtained.

Functions of elements disclosed herein may be implemented using circuit configurations or processing circuit configurations including a general purpose processor, a special purpose processor, an integrated circuit, an application specific integrated circuit (ASIC), a conventional circuit configuration, and/or a combination of these that are configured to execute the disclosed elements or programmed to execute the disclosed functions. A processor is regarded as a processing circuit configuration or a circuit configuration when the processor includes a transistor and other circuit configuration in the inside. In the present disclosure, a circuit configuration, unit, or means is hardware that executes the mentioned functions or hardware programmed to execute the functions. The hardware may be any of the hardware disclosed herein or other known hardware programmed to execute the mentioned functions or configured to execute the mentioned functions. When hardware is a processor that may be regarded as a circuit configuration of a certain type, a circuit configuration, means, or unit is a combination of hardware and software, software used to configure hardware, and/or a processor.

1. An information processing system comprising:
a signal processing device including a first circuitry; and
an auxiliary device connected to the signal processing device and including a second circuitry,
wherein the first circuitry:
generates a clock signal and a plurality of data signals having different relative phase differences with respect to the clock signal; and
transmits the clock signal and the plurality of data signals to the second circuitry,
the second circuitry:
receives the clock signal and the plurality of data signals;
generates response data based on the clock signal and the plurality of data signals; and
transmits the response data to the first circuitry, and
the first circuitry:
receives the response data;
includes a storage circuit that stores expected value data; and
determines that the auxiliary device is a genuine product or the auxiliary device is a non-genuine product based on the expected value data and the response data.

2. The information processing system according to claim 1, wherein
the second circuitry includes a plurality of transmission paths,
the clock signal or the plurality of data signals are received by the second circuitry via any one of the plurality of transmission paths, and
a delay amount of the clock signal or the plurality of data signals in each of the plurality of transmission paths is different for each of the plurality of transmission paths.

3. The information processing system according to claim 1, wherein
the plurality of data signals include a first instruction signal including an instruction to change drive capability of the auxiliary device and a second instruction signal including an instruction to request transmission of a data signal at a predetermined voltage level,
the second circuitry includes a first capability changing circuit that changes drive capability of the auxiliary device based on the first instruction signal, and
the second circuitry generates the response data based on the clock signal and the second instruction signal.

4. The information processing system according to claim 3, wherein
the first circuitry:
includes a constant current source that generates sink current flowing from the auxiliary device to the signal processing device or source current flowing from the signal processing device to the auxiliary device; and
sets a current value of the sink current or the source current.

5. The information processing system according to claim 1, wherein
the storage circuit stores a plurality of pieces of expected value data,
the first circuitry selects any one piece of expected value data among the plurality of pieces of expected value data as specific data, and
the first circuitry determines that the auxiliary device is a genuine product or that the auxiliary device is a non-genuine product based on the specific data and the response data.

6. The information processing system according to claim 5, wherein
the storage circuit stores a correspondence relationship between a temperature and the plurality of pieces of expected value data,
the first circuitry includes a temperature measurement unit, and
the first circuitry selects, as the specific data, expected value data corresponding to a temperature measured by the temperature measurement unit.

7. The information processing system according to claim 5, wherein
the first circuitry sets a circuit that allows the plurality of data signals to pass,
the storage circuit stores a correspondence relationship between the circuit set by the first circuitry and the plurality of pieces of expected value data, and
the first circuitry selects, as the specific data, expected value data corresponding to the set circuit.

8. The information processing system according to claim 1, wherein
the second circuitry includes a plurality of combinational circuits and a flip-flop circuit arranged in each of a plurality of connection paths connecting the plurality of combinational circuits,
the second circuitry includes a scan circuit formed by serially connecting each of the flip-flop circuits, and
the plurality of data signals received by the second circuitry are input to at least one of an input unit of the scan circuit and any one of the plurality of combinational circuits.

9. The information processing system according to claim 1, wherein the first circuitry switches a frequency of the clock signal between a first frequency and a second frequency having a frequency higher than the first frequency.

10. The information processing system according to claim 1, wherein
the first circuitry includes a first voltage variable circuit that switches a voltage level of the plurality of data signals between a first voltage and a second voltage at a higher voltage level than the first voltage, and
the second circuitry includes a second voltage variable circuit that switches a receivable voltage level between the first voltage and the second voltage.

11. An information processing system comprising:
a signal processing device including a first circuitry; and
an auxiliary device connected to the signal processing device and including a second circuitry,
wherein the first circuitry:
generates a clock signal and one data signal; and
transmits the clock signal and the one data signal to the second circuitry,
the second circuitry:
includes a plurality of transmission paths;
receives the clock signal and the one data signal that pass through at least two transmission paths among the plurality of transmission paths;
generates response data based on the clock signal and the one data signal; and
transmits the response data to the first circuitry,
a delay amount of the clock signal or the one data signal in each of the plurality of transmission paths is different for each of the plurality of transmission paths, and
the first circuitry:
receives the response data;
includes a storage circuit that stores expected value data; and
determines that the auxiliary device is a genuine product or the auxiliary device is a non-genuine product based on the expected value data and the response data.

12. An auxiliary device included in the information processing system according to claim 1.

13. An auxiliary device including a second circuitry, wherein
the second circuitry receives a clock signal and a plurality of data signals,
the second circuitry includes a plurality of transmission paths, a delay element provided in each of the plurality of transmission paths, a flip-flop circuit, and a selector to which the clock signal or the plurality of data signals are input,
a number of the delay elements is different for each of the plurality of transmission paths, and
the clock signal or the plurality of data signals that pass through the delay element are input to the selector.

14. A signal processing device including a first circuitry according to claim 1, wherein
an auxiliary device including a second circuitry is connected to the signal processing device,
the first circuitry:
generates a clock signal and a plurality of data signals having different relative phase differences with respect to the clock signal;
transmits the clock signal and the plurality of data signals to the second circuitry;
receives response data that the second circuitry generates based on the clock signal and the plurality of data signals;
includes a storage circuit that stores expected value data; and
determines that the auxiliary device is a genuine product or the auxiliary device is a non-genuine product based on the expected value data and the response data.
